(19) United States
(12) Patent Application Publication
(10) Pub. No.: US 2018/0087890 A1
(43) Pub. Date: Mar. 29, 2018

(54) METHOD FOR CONTROLLING SENSOR AND ELECTRONIC DEVICE THEREOF

(71) Applicant: SAMSUNG ELECTRONICS CO., LTD., Suwon-si (KR)

(72) Inventors: Jeong-Ho CHO, Hwaseong-si (KR); Il-Young KIM, Suwon-si (KR); Jeongyeol LEE, Suwon-si (KR); Jongah KIM, Suwon-si (KR); Seunggoo KANG, Seongnam-si (KR); Hyungjin RHO, Yongin-si (KR); Jeong-Min PARK, Hwaseong-si (KR); Kihuk LEE, Suwon-si (KR)

(21) Appl. No.: 15/713,177

(22) Filed: Sep. 22, 2017

(30) Foreign Application Priority Data
Sep. 23, 2016 (KR) 10-2016-0122301

(51) Int. Cl. G01B 9/02; G06F 21/32; G06F 3/01; G06K 9/00; G01B 11/14

(52) U.S. Cl. CPC G01B 9/02002; G06F 21/32; G01B 11/14; G06K 9/00597; G01B 9/02041; G06F 3/015

(57) ABSTRACT

Various embodiments of the present disclosure relate to an apparatus and a method for controlling an optical sensor in an electronic device. The electronic device includes: a light emission element configured to emit light; a first light reception element configured to detect an intensity of light which is reflected from an object based on the light emitted by the light emission element; a second light reception element configured to detect a shape of the object using the light which is reflected from the object based on the light emitted by the light emission element; and a processor. The processor is configured to: control the light emission element to emit light with an intensity corresponding to an operation mode of the electronic device; and receive light which is reflected from the object via the first light reception element or the second light reception element based on the operation mode of the electronic device. Other embodiments are possible.

### CROSS-REFERENCE TO RELATED APPLICATION

The present application is based on and claims priority under 35 U.S.C. § 119 to an application filed in the Korean Intellectual Property Office on Sep. 23, 2016 and assigned Serial No. 10-2016-0122301, the content of which are incorporated by reference herein in its entirety.

### BACKGROUND

### 1. Technical Field

The present disclosure relates generally to an apparatus and a method for controlling an optical sensor in an electronic device.

### 2. Description of Related Art

With the enhancement of information and communication technology, various security systems are required. For example, automated teller machines (ATMs) of banks require security systems to identify users who request asset management in order to tighten security regarding users' assets. Even in the field of developing new technology like laboratories, security systems for identifying persons who come in and go out are required.

Various security technologies have been developed to satisfy users' demands for tightening security of electronic devices. For example, electronic devices may provide security technology using unique information of various users, based on which users can be identified, such as user's fingerprint, voice, handwriting, iris, or the like, as well as passwords set by users.

### SUMMARY

When an electronic device identifies a user using user's iris, the electronic device may identify the user based on a shape or color of an iris or a shape of a retinal capillary which is detected by analyzing light reflected from the user's iris. In this case, the electronic device may emit light using an infrared light emission element which has a relatively high output in order to collect light reflected from the user's iris. Accordingly, there may be a problem that the light emitted to recognize the iris in the electronic device provides direct stimuli to user's eyes or causes damages to user's eyes.

To address this problem, iris recognition technology is making safety regulations for preventing damage to user's eyes. For example, in the case where a light emission element of an electronic device keeps emitting light during 0.3 second every one second with power of 3000 W/m², if a distance between the light emission element of the electronic device and user's eyes is 1.5 cm and the eyes are exposed to the emitted light during 10 seconds or more, the light is set to be dangerous according to safety regulations of iris recognition. In addition, in the case where a light emission element of an electronic device keeps emitting light during 0.5 second every one second with power of 3000 W/m², if a distance between the light emission element of the electronic device and user's eyes is 1.9 cm and the eyes are exposed to the emitted light during 10 seconds or more, the light is set to be dangerous according to safety regulations of iris recognition.

However, a sensor for recognizing an iris may not recognize a distance to a user. Since a proximity sensor emits light with relatively limited power compared to the iris recognition sensor, there is a limit to recognizing a distance. Accordingly, there may be a problem that electronic devices do not recognize a distance to a user according to safety regulations applied to iris recognition technology.

To address the above-discussed deficiencies, it is an example aspect of the present disclosure to provide at least the advantages described below. Accordingly, the present disclosure provides an apparatus and a method for controlling an optical sensor in an electronic device.

Another example aspect of the present disclosure provides an apparatus and a method for controlling iris recognition in an electronic device.

According to an example aspect of the present disclosure, an electronic device is provided, including: a light emission element comprising light emitting circuitry configured to emit light; a first light reception element comprising light receiving circuitry configured to detect an intensity of light reflected from an object based on the light emitted by the light emission element; a second light reception element comprising light receiving circuitry configured to detect a shape of the object using the light which is reflected from the object based on the light emitted by the light emission element; and a processor, the processor configured to: control the light emission element to emit light with an intensity corresponding to an operation mode of the electronic device; and receive light which is reflected from the object via at least one of the first light reception element or the second light reception element based on the operation mode of the electronic device.

According to another example aspect of the present disclosure, a method of operating an electronic device is provided, including: emitting light of an intensity corresponding to an operation mode of the electronic device via a light emission element of the electronic device; and receiving light reflected from an object via at least one of a first light reception element or a second light reception element of the electronic device based on the operation mode of the electronic device, wherein the first light reception element is configured to detect an intensity of light which is reflected from the object based on the light emitted by the light emission element, and the second light reception element is configured to detect a shape of the object using the light which is reflected from the object based on the light emitted by the light emission element.

According to another example aspect of the present disclosure, a portable electronic device is provided, including: a housing including a first surface, a second surface facing a direction opposite the first surface, and a side surface which surrounds a space between the first surface and the second surface; a display which is exposed via a first region of the first surface; a speaker which is exposed via a second region of the first surface and is disposed adjacent to a first border of the display; a light emission element comprising light emitting circuitry which is exposed via the second region of the first surface and is disposed adjacent to the first border of the display; a first light reception element comprising light receiving circuitry which is exposed via the second region of the first surface, is disposed adjacent to the first border of the display, and has a first resolution; a second light reception element comprising light receiving circuitry which is exposed via the second region of the first surface, is disposed adjacent to the first border of the display, and has a second resolution higher than the first resolution, the second light reception element being disposed farther away from the light emission element than the first light reception element; a processor electrically or operatively connected to the display, the speaker, the light emission element, the first light reception element, and the second light reception element; and a memory electrically connected with the processor, wherein, the memory stores instructions, which when executed by the processor, cause the processor to: control the light emission element to generate light of a first level during a first time period; detect at least a part of reflected light of the light of the first level using the first light reception element; control the light emission element to generate light of a second level which is higher than the first level during a second time period immediately after the first time period; detect at least a part of reflected light of the light of the second level using the second light reception element; perform biometric recognition using the detected at least part of the reflected light of the light of the second level; and perform authentication based on a result of performing the biometric recognition.

### BRIEF DESCRIPTION OF THE DRAWINGS

The above and other aspects, features and attendant advantages of the present disclosure will be more apparent and readily appreciated from the following detailed description, taken in conjunction with the accompanying drawings, in which like reference numerals refer to like elements, and wherein:

FIGS. 1A and 1B are perspective views illustrating an example front surface of an electronic device according to various example embodiments of the present disclosure;

FIG. 2A is a diagram illustrating an example electronic device in a network environment according to various example embodiments of the present disclosure;

FIG. 2B is a diagram illustrating an example configuration of a light emission module according to various example embodiments of the present disclosure;

FIG. 3 is a block diagram illustrating an example electronic device according to various example embodiments of the present disclosure;

FIG. 4 is a block diagram illustrating an example program module according to various embodiments of the present disclosure;

FIG. 5 is a flowchart illustrating an example method of controlling an optical sensor in an electronic device according to various example embodiments of the present disclosure;

FIG. 6 is a flowchart illustrating an example method of controlling a proximity sensor in an electronic device according to various example embodiments of the present disclosure;

FIG. 7 is a flowchart illustrating an example method of controlling an iris sensor in an electronic device according to various example embodiments of the present disclosure;

FIG. 8 is a diagram illustrating example light emission intensity of a light emission module for iris recognition in an electronic device according to various example embodiments of the present disclosure;

FIGS. 9A and 9B are diagrams illustrating example distance configuration between an electronic device and a user for iris recognition according to various example embodiments of the present disclosure;

FIGS. 10A and 10B are diagrams illustrating example screen configurations for iris recognition in an electronic device according to various example embodiments of the present disclosure;

FIG. 11 is a flowchart illustrating an example method of measuring a distance to a user in an electronic device according to various example embodiments of the present disclosure;

FIG. 12 is a flowchart illustrating an example method of recognizing an iris in an electronic device according to various example embodiments of the present disclosure;

FIG. 13 is a diagram illustrating an example screen configuration for iris recognition in an electronic device according to various example embodiments of the present disclosure; and

FIG. 14 is a flowchart illustrating an example method of recognizing an iris in an electronic device according to various example embodiments of the present disclosure.

### DETAILED DESCRIPTION

Hereinafter, various example embodiments of the present disclosure are described in greater detail with reference to the accompanying drawings. It should be understood, however, that it is not intended to limit the various example embodiments of the present disclosure to the particular forms disclosed herein, but, instead, it is intended to cover all modifications, equivalents, and alternatives falling within the spirit and scope of the various example embodiments of the present disclosure. Like reference numerals denote like components throughout the drawings. A singular expression includes a plural concept unless there is a contextually distinctive difference therebetween.

In the present disclosure, an expression “A or B”, “A and/or B”, or the like may include all possible combinations of items enumerated together. Although expressions such as “1^{st}”, “2^{nd}”, “first”, and “second” may be used to express corresponding elements, it is not intended to limit the corresponding elements. When a certain (e.g., 1^{st}) element is mentioned as being “operatively or communicatively coupled with/to” or “connected to” a different (e.g., 2^{nd}) element, the certain element is directly coupled with/to another element or can be coupled with/to the different element via another (e.g., 3^{rd}) element.

An expression “configured to” used in the present document may be interchangeably used with, for example, “suitable for”, “having the capacity to”, “adapted to”, “made to”, “capable of”, or “designed to” in a hardware or software manner according to a situation. In a certain situation, an expressed “a device configured to” may imply that the device is “capable of” together with other devices or components. For example, “a processor configured to perform A, B, and C” may refer, for example, to a dedicated processor (e.g., an embedded processor) for performing a corresponding operation or a generic-purpose processor (e.g., Central Processing Unit (CPU) or an application processor) capable of performing corresponding operations by executing one or more software programs stored in a memory device.

An electronic device according to various embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic appcessory, an electronic tattoo, a smart mirror, or a smart watch), or the like, but is not limited thereto.

According to some embodiments, the electronic device (ex. home appliance) may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various embodiments of the present disclosure may be a combination of one or more of the aforementioned various devices. The electronic device according to some embodiments of the present disclosure may be a flexible device (or foldable device). Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

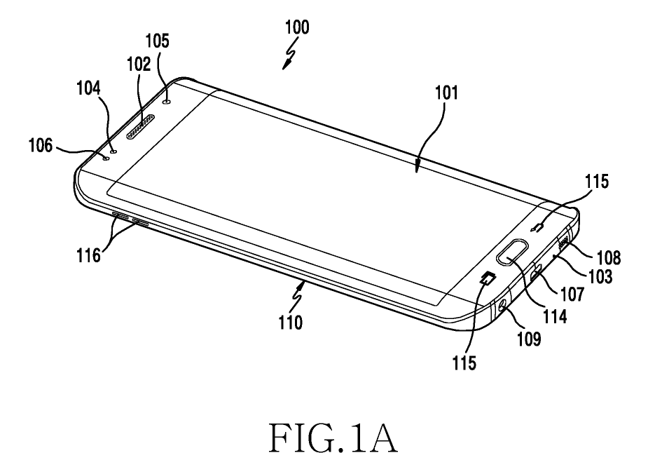

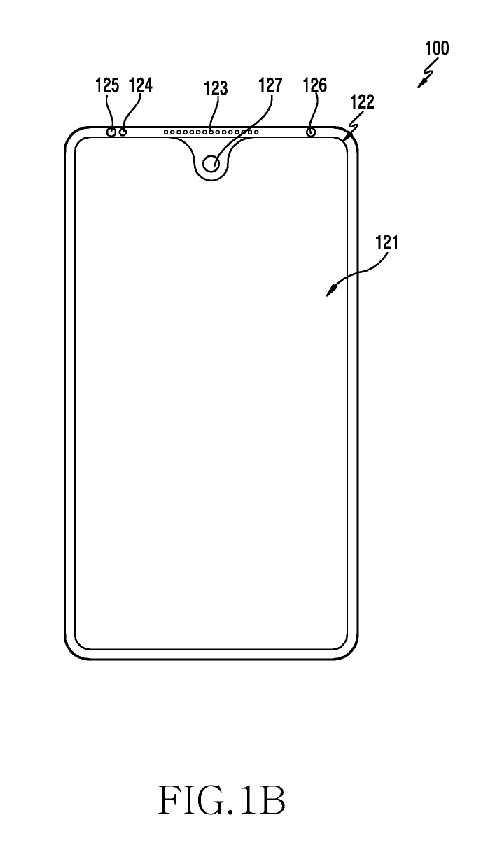

FIGS. 1A and 1B are perspective views illustrating an example front surface of an electronic device according to various example embodiments of the present disclosure.

Referring to FIG. 1A, the electronic device 100 may include a housing 110. According to an example embodiment, the housing 110 may include a metal member or both a metal member and a nonmetal member. According to an example embodiment, a display 101 including a window (for example, a front window or a glass plate) may be disposed on a front surface (for example, a first surface) of the housing 110. According to an example embodiment, the electronic device 100 may include a receiver (speaker) 102 to output a voice of the other person. The receiver 102 may be disposed in the housing 110. According to an example embodiment, the electronic device 100 may include a microphone device 103 to transmit a user's voice to the other person. The microphone device 103 may be disposed in the housing 110. According to an example embodiment, the electronic device 100 may include at least one key input device disposed in the housing 110. For example, the key input device may include a home key button 114 which is disposed on the front surface of the housing 110, touch pads 115 which are disposed on both sides of the home key button 114, and a side key button 116 which is disposed on a side surface of the housing 110.

According to an example embodiment, a speaker device 108 may be disposed on one side of the microphone device 103. According to an example embodiment, an interface connector port 107 may be disposed on the other side of the microphone device 103 to perform a data transmission and reception function by means of an external device and to charge the electronic device 100 by receiving external power. According to an example embodiment, an ear jack hole 109 may be disposed on one side of the interface connector port 107.

According to an example embodiment, a light emission sensor (light emission element) 106 may be disposed on one side of the receiver (e.g., a speaker) 102, and a light reception sensor (for example, a light reception element) 104 corresponding to a proximity sensor may be disposed adjacent to the light emission sensor 106. According to an example embodiment, light reception sensor (for example, an iris recognition camera) 105 corresponding to an iris sensor for iris recognition may be disposed on the other side of the receiver 102.

Referring to FIG. 1B, the electronic device 100 may include a housing. According to an example embodiment, the housing may comprise a metal member or both a metal member and a nonmetal member. According to an example embodiment, a display 121 including a window (for example, a front window or a glass plate) may be disposed on a first region of a front surface (for example, a first surface) of the housing. According to an example embodiment, a camera 127 may be disposed on at least a part of the first region of the front surface (for example, the first surface) of the housing.

According to an example embodiment, the housing may include a metal member formed on a second region 122 (for example, a border of the display 121) of the front surface (for example, the first surface) of the housing. According to an example embodiment, a receiver (e.g., a speaker) 123 may be disposed on the second region 122 to output a voice of another person or any other sound output. According to an example embodiment, a light emission element (e.g., including light emitting circuitry) 125 may be disposed on one side of the receiver 123, and a light reception element (e.g., including light receiving circuitry) 124 corresponding to, for example, a proximity sensor may be disposed adjacent to the light emission sensor 125. According to an example embodiment, a light reception element (for example, an iris scanner, e.g., including light receiving circuitry) 126 corresponding to an iris sensor for iris recognition may be disposed on the other side of the receiver 123.

According to an example embodiment, the housing may include a side member forming the second region 122 of the front surface (for example, the first surface) of the housing. According to an example embodiment, at least one of a microphone device, a speaker, and a hardware button (for example, a side key button) may be disposed on a rear surface (for example, a second surface) or a side surface of the housing.

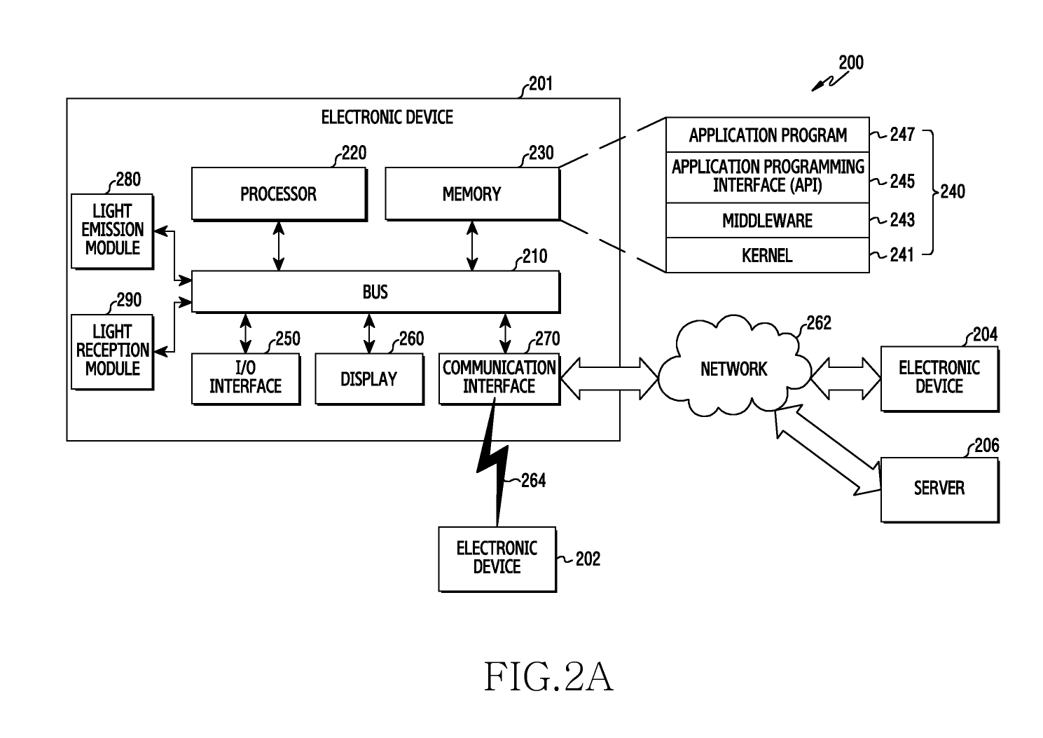

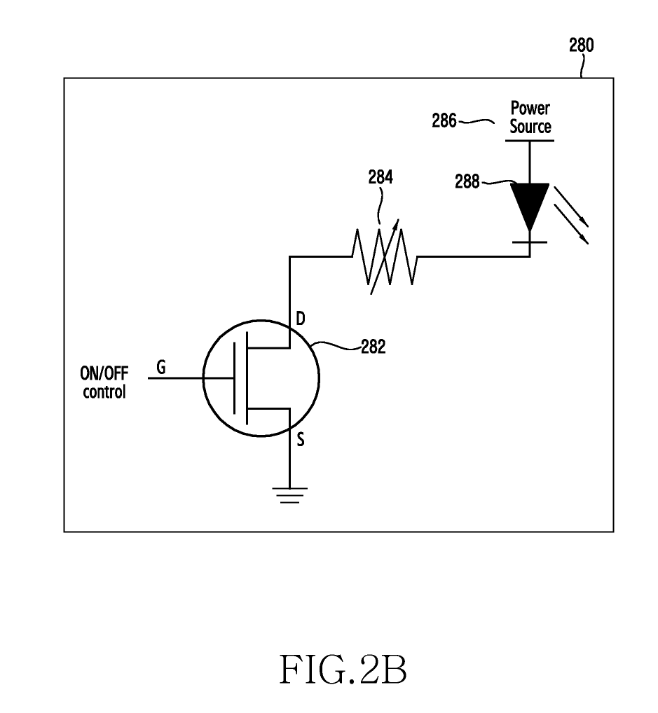

FIG. 2A is a diagram illustrating an example electronic device 201 in a network environment 200 according to various example embodiments of the present disclosure.

Referring to FIG. 2A, the electronic device 201 may include a bus 210, a processor (e.g., including processing circuitry) 220, a memory 230, an input/output interface (e.g., including input/output circuitry) 250, a display 260, a communication interface (e.g., including communication circuitry) 270, a light emission module (a light emission sensor, e.g., including light emitting circuitry) 280, and a light reception module (a light reception sensor, e.g., including light emitting circuitry) 290. According to an example embodiment, the electronic device 201 may omit at least one of the above-described elements or may further include other element(s).

The bus 210 may interconnect the above-described elements 220 to 290, and may include a circuit for conveying communications (for example, a control message and/or data) among the above-described elements.

The processor 220 may include various processing circuitry, such as, for example, and without limitation, one or more of a dedicated processor, a central processing unit (CPU), an application processor (AP), an image signal processor (ISP), or a communication processor (CP). The processor 120 may perform, for example, an operation or data processing associated with control and/or communication of at least one other element(s) of the electronic device 201.

According to an example embodiment, the processor 220 may control a light emission intensity of the light emission module 280 so as to correspond to an operation mode of the electronic device 201. For example, when the electronic device 201 is operated in a proximity mode to determine the proximity or distance of an object, the processor 220 may control the light emission intensity of the light emission module 280 to be a first level. When the electronic device 201 is operated in an iris recognition mode to recognize an iris, the processor 220 may control the light emission intensity of the light emission module 280 to be a second level or a third level. For example, the light emission intensity of the light emission module 280 may increase in order of the first level, the second level, and the third level.

According to an example embodiment, the processor 220 may determine the proximity or distance of an object to the electronic device 201 using the light emission module 280 and the light reception module 290. For example, when the electronic device 201 is operated in the proximity mode, the processor 220 may control the light emission module 280 to emit light with the intensity of the first level. The processor 220 may determine the proximity or distance of the object by collecting light reflected from the object using the light reception module 290 (for example, a light reception module of a proximity sensor). For example, the processor 220 may detect an amount of received light reflected from the object by comparing an amount of received light in a light emission section and an amount of received light in a non-light emission section of the light emission module 280, which are collected through the light reception module 290. The processor 220 may determine the proximity or distance of the object based on the amount of received light reflected from the object. For example, the processor 220 may change the operation mode of the electronic device 210 to the proximity mode based on a characteristic of an application executed in the electronic device 201.

According to an example embodiment, the processor 220 may detect a distance between the electronic device 201 and a user using the light emission module 280 and the light reception module 290. For example, the processor 220 may control the light emission module 280 to emit light with the intensity of the second level during a preparation section of an iris recognition mode of the electronic device 201. The processor 220 may estimate a distance to the object by collecting light reflected from the object using the light reception module 290 (for example, a light reception module of a proximity sensor). For example, the processor 220 may detect an amount of received light reflected from the object by comparing an amount of received light in the light emission section and an amount of received light in the non-light emission section of the light emission module 280, which are collected through the light reception module 290. The processor 220 may estimate the distance to the object based on the amount of received light reflected from the object. For example, the preparation section of the iris recognition mode may include a start section of the iris recognition mode or a section in which light for recognizing an iris is not emitted from the light emission module 280 in an iris recognition period of the iris sensor.

According to an example embodiment, the processor 220 may be configured to perform control to selectively perform iris recognition based on a distance between the electronic device 201 and the user. For example, when the distance to the user is shorter than a pre-defined safety distance, the processor 220 may determine that light emitted from the light emission module 280 to recognize an iris may be harmful to a user's eyes. Accordingly, the processor 220 may put a limit to recognizing the iris. For example, the processor 220 may put a limit to driving the light emission module 280 to emit light to recognize the iris. Additionally or alternatively, the processor 220 may be configured to perform control to output position change request information. For example, when the distance to the user is longer than the pre-defined safety distance, the processor 220 may control the light emission module 280 to emit light with the intensity of the third level in order to perform iris recognition. The processor 220 may detect iris information of the object by collecting light reflected from the object through the light reception module 290 (for example, a light reception module of an iris sensor). The processor 220 may identify the user using the iris information of the object. For example, the iris information may include at least one of a shape of an iris, a color of an iris, and a shape of a retinal capillary. For example, the safety distance may be set based on the intensity of the third level of the light emission module 280 and a light emission holding time.

According to an example embodiment, the processor 220 may control at least one of the light emission intensity and a light emission time of the light emission module 280 for iris recognition based on the distance between the electronic device 201 and the user. For example, the processor 220 may adjust at least one of the light emission time and the light emission intensity of the light emission module 280 during the iris recognition period based on the distance between the electronic device 201 and the user. For example, as the distance between the electronic device 201 and the user is shorter, the processor 220 may set the light emission intensity to be relatively smaller or set the light emission time to be relatively shorter.

The memory 230 may include a volatile memory and/or nonvolatile memory. The memory 230 may store, for example, instructions or data associated with at least one other element(s) of the electronic device 201. According to an example embodiment, the memory 230 may store software and/or a program 240. The program 240 may include, for example, a kernel 241, a middleware 243, an application programming interface (API) 145, or an application program (or an “application”) 247. At least a portion of the kernel 241, the middleware 243, or the API 245 may be called an “operating system (OS).”

The kernel 241 may control or manage system resources (for example, the bus 210, the processor 220, the memory 230, or the like) that are used to execute operations or functions of other programs (for example, the middleware 243, the API 245, or the application program 247). Furthermore, the kernel 241 may provide an interface that allows the middleware 243, the API 245, or the application program 247 to access discrete elements of the electronic device 201 so as to control or manage system resources.

The middleware 243 may perform a mediation role such that the API 245 or the application program 247 communicates with the kernel 241 to exchange data. Furthermore, the middleware 243 may process one or more task requests received from the application program 247 according to a priority. For example, the middleware 243 may assign the priority, which makes it possible to use a system resource (for example, the bus 210, the processor 220, the memory 230, or the like) of the electronic device 201, to at least one of the application program 247, and may process the one or more task requests. The API 245 may be an interface through which the application program 247 controls a function provided by the kernel 241 or the middleware 243, and may include, for example, at least one interface or function (for example, an instruction) for a file control, a window control, image processing, a character control, or the like.

The input/output interface 250 may include various input/output circuitry and perform a role of an interface to transmit an instruction or data, inputted from a user or another external device, to other element(s) of the electronic device 201.

The display 260 may include, for example, a liquid crystal display (LCD), a light emitting diode (LED) display, an organic LED (OLED) display, a microelectromechanical systems (MEMS) display, or an electronic paper display, or the like, but is not limited thereto. The display 260 may display, for example, various contents (for example, a text, an image, a video, an icon, and/or a symbol) to a user. The display 260 may include a touch screen and may receive, for example, a touch, a gesture, proximity, or hovering input using an electronic pen or a portion of a user's body.

The communication interface 270 may include various communication circuitry and establish communication between the electronic device 201 and an external device (for example, a first external electronic device 202, a second external electronic device 204, or a server 206). For example, the communication interface 270 may be connected to a network 262 through wireless communication or wired communication to communicate with the external device (for example, the second external electronic device 204 or the server 206). Additionally, the communication interface 270 may establish a short-range local-area communication connection 264 with another electronic device, e.g., first external electronic device 202, and/or a network, e.g., network 262.

The wireless communication may include cellular communication using at least one of, for example, long term evolution (LTE), LTE Advanced (LTE-A), code division multiple access (CDMA), wideband CDMA (WCDMA), universal mobile telecommunications system (UMTS), wireless broadband (WiBro), global system for mobile communications (GSM), or the like. According to an example embodiment, the wireless communication (264) may include, for example, at least one of wireless fidelity (WiFi), Bluetooth, Bluetooth low energy (BLE), Zigbee, near field communication (NFC), magnetic secure transmission, radio frequency (RF), or a body area network (BAN). According to an example embodiment, the wireless communication may include global navigation satellite system (GNSS). The GNSS may include, for example, global positioning system (GPS), global navigation satellite system (Glonass), BeiDou navigation satellite system (hereinafter, referred to as “BeiDou”) or Galileo (the European global satellite-based navigation system). Hereinafter, GPS and GNSS may be interchangeably used in the following descriptions. The wired communication may include at least one of, for example, a universal serial bus (USB), a high-definition multimedia interface (HDMI), a recommended standard-232 (RS-232), power line communication, or a plain old telephone service (POTS). The network 262 may include at least one of telecommunications networks, for example, a computer network (for example, a local area network (LAN) or a wide area network (WAN)), an internet, or a telephone network.

Each of the first and second external electronic devices 202 and 204 may be the same or different type of device as or from the electronic device 201. According to various embodiments, all or a part of operations that the electronic device 201 will perform may be executed by another or plural other electronic devices (for example, the electronic devices 202 and 204 and the server 206). According to an example embodiment, in the case where the electronic device 201 executes any function or service automatically or in response to a request, the electronic device 201 may not perform the function or the service internally, but, alternatively or additionally, it may request at least a portion of a function associated with the electronic device 201 at other device (for example, the electronic device 202 or 204 or the server 206). The other electronic device (for example, the electronic device 202 or 204 or the server 206) may execute the requested function or additional function and may transmit the execution result to the electronic device 201. The electronic device 201 may provide the requested function or service using the received result or may additionally process the received result to provide the requested function or service. To achieve this, for example, cloud computing, distributed computing, or client-server computing may be used.

The light emission module 280 may include various light emitting circuitry to emit light for determining the proximity or distance of an object or may emit light for iris recognition. For example, the light emission module 280 may emit light with an intensity corresponding to an operation mode of the electronic device 201. For example, the light emission module 280 may include various light emitting circuitry such as, for example, and without limitation, an infrared light emitting diode (LED).

The light reception module 290 may include various light receiving circuitry and may include a first light reception module corresponding to the proximity sensor and a second light reception module corresponding to the iris sensor. For example, the first light reception module may determine an intensity of light (an amount of light) reflected from an object based on a time at which the light emission module 280 emits light when the electronic device 201 is operated in the proximity mode or operated in the preparation section of the iris recognition mode. For example, the first light reception module may determine the proximity or distance of the corresponding object based on the intensity of the light reflected from the object. For example, when the intensity of the light reflected from the object exceeds a reference intensity, the first light reception module may determine the proximity or distance of the object based on an elapsed time from the time when the light emission module 280 emits light until the time when the first light reception module receives light. For example, the first light reception module may include, without limitation, a photodiode. Additionally or alternatively, the first light reception module may be configured in the form of a package with an illuminance sensor. In this case, the first light reception module may receive the light which is reflected from the object to determine the proximity or distance of the object, and receive external light simultaneously. For example, the second light reception module may detect a shape of the object using the light reflected from the object based on the time at which the light emission module 280 emits light. The second light reception module may be spaced apart from the light emission module 280 by a reference distance or more to exactly recognize the shape (pattern) of the iris. For example, the second light reception module may be configured in the form of a camera (for example, a front camera of the electronic device) or a scanner for detecting the shape of the object. When the second light reception module is configured in the form of a camera, the second light reception module may receive light reflected from the object and may obtain an image having pixels more than or equal to reference pixels (for example, 200 pixels).

According to various example embodiments of the present disclosure, the processor 220 may detect a user's gesture using the first light reception module corresponding to the proximity sensor. For example, the processor 220 may detect an input of a user's gesture using a difference in amounts of light received in respective channels through the first light reception module.

According to various example embodiments of the present disclosure, the processor 220 may determine a component of the object using the light emission module 280 and the first light reception module corresponding to the proximity sensor. For example, when the light emission module 280 includes a spectrum sensor, the processor 220 may control the light emission module 280 to emit light in various bands. The processor 220 may determine the component of the object by collecting light reflected from the object through the first light reception module.

According to various example embodiments of the present disclosure, the light emission module 280 and the light reception module 290 may be controlled by a supplementary processor or a low power processor which is separate from the processor 220.

FIG. 2B is a diagram illustrating an example configuration of the light emission module according to various example embodiments of the present disclosure.

Referring to FIG. 2B, the light emission module 280 may have a power source 286 of a reference voltage (for example, 3.3 V) connected to a drain of a transistor 282, and may include a variable resistance (e.g., including a variable resistor) 284 between the transistor 282 and the power source 286 to be able to control a current therebetween.

According to an example embodiment, the light emission module 280 may adjust an intensity of light emitted from a photodiode 288 by adjusting the current of the photodiode 288 based on a change in a resistance value of the variable resistance 284 under the control of the processor 220. Additionally or alternatively, the light emission module 280 may be activated (ON) or inactivated (OFF) so as to correspond to an operation period of a control signal which is provided through a gate of the transistor 282.

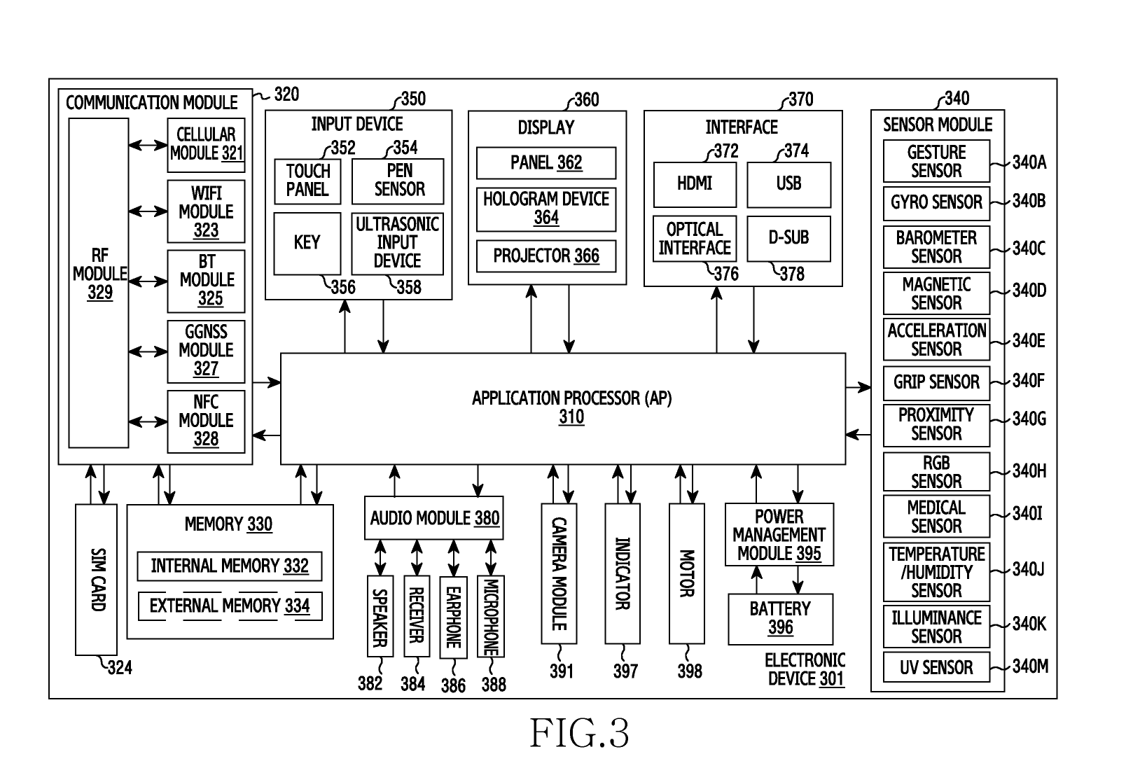

FIG. 3 is a block diagram illustrating an example electronic device 301 according to various example embodiments. The electronic device 301 may include, for example, an entirety or a part of the electronic device 201 illustrated in FIG. 2A.

Referring to FIG. 3, the electronic device 301 may include one or more processors (for example, an AP) (e.g., including processing circuitry) 310, a communication module (e.g., including communication circuitry) 320, a subscriber identification module 324, a memory 330, a sensor module 340, an input device (e.g., including input circuitry) 350, a display 360, an interface (e.g., including interface circuitry) 370, an audio module 380, a camera module 391, a power management module 395, a battery 396, an indicator 397, and a motor 398.

For example, the processor 310 may include various processing circuitry and drive an operating system (OS) or an application program to control a plurality of hardware or software elements connected to the processor 310, and may process and compute a variety of data. The processor 310 may be implemented by using a System on Chip (SoC), for example. According to an example embodiment, the processor 310 may further include a graphic processing unit (GPU) and/or an image signal processor (ISP). The processor 310 may include at least a part (for example, a cellular module 321) of elements illustrated in FIG. 3. The processor 310 may load and process an instruction or data, which is received from at least one of the other elements (for example, a nonvolatile memory), at a volatile memory, and may store resulting data at a nonvolatile memory.

The communication module 320 may be configured the same as or similar to the communication interface 270 of FIG. 2. The communication module 320 may include various communication circuitry, such as, for example, and without limitation, at least one of a cellular module 321, a Wi-Fi module 323, a Bluetooth module 325, a GNSS module 327, an NFC module 328, and an RF module 329.

The cellular module 321 may provide voice communication, video communication, a messaging service, an Internet service or the like through a communication network. According to an example embodiment, the cellular module 321 may perform discrimination and authentication of the electronic device 301 within a communication network using the subscriber identification module 324 (for example, a SIM card). According to an example embodiment, the cellular module 321 may perform at least a portion of functions that the processor 310 provides. According to an example embodiment, the cellular module 321 may include a communication processor (CP).

According to a certain embodiment, at least a portion (for example, two or more) of the cellular module 321, the Wi-Fi module 323, the Bluetooth module 325, the GNSS module 327, or the NFC module 328 may be included within one Integrated Circuit (IC) or an IC package.

The RF module 329 may transmit and receive a communication signal (for example, an RF signal), for example. The RF module 329 may include a transceiver, a power amplifier module (PAM), a frequency filter, a low noise amplifier (LNA), an antenna, or the like. According to another embodiment, at least one of the cellular module 321, the Wi-Fi module 323, the Bluetooth module 325, the GNSS module 327, or the NFC module 328 may transmit and receive an RF signal through a separate RF module. The subscriber identification module 324 may include, for example, a card or an embedded SIM including a subscriber identification module, and may include unique identification information (for example, an integrated circuit card identifier (ICCID)) or subscriber information (for example, international mobile subscriber identity (IMSI)).

The memory 330 (for example, the memory 230 of FIG. 2) may include an internal memory 332 and/or an external memory 334. For example, the internal memory 332 may include at least one of a volatile memory (for example, a dynamic random access memory (DRAM), a static RAM (SRAM), or a synchronous DRAM (SDRAM)), and a nonvolatile memory (for example, a one-time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD)). The external memory 334 may include a flash drive, for example, compact flash (CF), secure digital (SD), micro secure digital (Micro-SD), mini secure digital (Mini-SD), extreme digital (xD), multimedia card (MMC), a memory stick, or the like. The external memory 334 may be functionally or physically connected to the electronic device 301 through various interfaces.

The sensor module 340 (for example, the sensor 280 of FIG. 2) may measure, for example, a physical quantity or may detect an operation state of the electronic device 301, and may convert the measured or detected information to an electrical signal. The sensor module 340 may include at least one of a gesture sensor 340A, a gyro sensor 340B, a barometer sensor 340C, a magnetic sensor 340D, an acceleration sensor 340E, a grip sensor 340F, a proximity sensor 340G, a color sensor 340H (for example, red, green, blue (RGB) sensor), a medical sensor 340I, a temperature/humidity sensor 340J, an illuminance sensor 340K, or an UV sensor 340M. Additionally or alternatively, the sensor module 340 may include, for example, an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 340 may further include a control circuit for controlling at least one sensor included therein. According to a certain embodiment, the electronic device 301 may further include a processor which is a part of the processor 310 or a separate element from the processor 310 and is configured to control the sensor module 340. The processor 310 may control the sensor module 340 while the processor 310 remains at a sleep state. For example, the temperature/humidity sensor 340J may include a plurality of temperature sensors arranged at different locations.

The input device 350 may include various input circuitry, such as, for example, and without limitation, a touch panel 352, a (digital) pen sensor 354, a key 356, or an ultrasonic input device 358. The touch panel 352 may use at least one of capacitive, resistive, infrared and ultrasonic detecting methods. Also, the touch panel 352 may further include a control circuit. The touch panel 352 may further include a tactile layer to provide a tactile reaction to a user. The (digital) pen sensor 354 may be, for example, a part of a touch panel or may include an additional sheet for recognition. The key 356 may include, for example, a physical button, an optical key, a keypad, and the like. The ultrasonic input device 358 may detect an ultrasonic wave, which is generated from an input tool, through a microphone (for example, the microphone 388), and may check data corresponding to the detected ultrasonic wave.

The display 360 (for example, the display 260 of FIG. 2) may include a panel 362, a hologram device 364, a projector 366, and/or a control circuit for controlling the aforementioned elements. The panel 362 may be implemented to be flexible, transparent, or wearable. The panel 362 and the touch panel 352 may be integrated into one or more modules. The hologram device 364 may display a stereoscopic image in a space using a light interference phenomenon. The projector 366 may project light onto a screen so as to display an image. The screen may be arranged inside or outside the electronic device 301.

The interface 370 may include various interface circuitry, such as, for example, and without limitation, an HDMI 372, a universal serial bus (USB) 374, an optical interface 376, or a D-subminiature (D-sub) 378. The interface 370 may be included, for example, in the communication interface 270 illustrated in FIG. 2. Additionally or alternatively, the interface 370 may include, for example, a mobile high definition link (MHL) interface, a SD card/multi-media card (MMC) interface, or an infrared data association (IrDA) standard interface.

The audio module 380 may convert a sound and an electric signal in dual directions. At least a portion of the audio module 380 may be included, for example, in the input/output interface 250 illustrated in FIG. 2. The audio module 380 may process, for example, sound information that is inputted or outputted through a speaker 382, a receiver 384, an earphone 386, or a microphone 388.

The camera module 391 may be, for example, a device for shooting a still image or a moving image, and according to an example embodiment, the camera module 391 may include, for example, at least one image sensor (for example, a front sensor or a rear sensor), a lens, an image signal processor (ISP), or a flash (for example, an LED or a xenon lamp). The power management module 395 may manage, for example, power of the electronic device 301.

The power management module 395 may include a power management integrated circuit (PMIC), a charger IC, or a battery or fuel gauge. The PMIC may have a wired charging method and/or a wireless charging method. The wireless charging method may include, for example, a magnetic resonance method, a magnetic induction method or an electromagnetic wave method. The PMIC may further include an additional circuit for wirelessly charging, for example, a coil loop, a resonance circuit, or a rectifier, and the like. The battery gauge may measure, for example, a remaining capacity of the battery 396 and a voltage, current or temperature thereof while the battery is charged. The battery 396 may include, for example, a rechargeable battery and/or a solar battery.

The indicator 397 may display a specific state of the electronic device 301 or a portion thereof (for example, the processor 310), such as a booting state, a message state, a charging state, or the like. The motor 398 may convert an electrical signal into a mechanical vibration and may generate vibration, a haptic effect, and the like. For example, the electronic device 301 may include a mobile TV supporting device (for example, a GPU) for processing media data according to the standards of digital multimedia broadcasting (DMB), digital video broadcasting (DVB), MediaFlo™, or the like.

Each of the elements described in the present disclosure may be configured with one or more components, and the names of the elements may be changed according to the type of the electronic device. According to various embodiments, some elements of the electronic device (for example, the electronic device 301) may be omitted or other additional elements may be added. Furthermore, some of the elements may be combined with each other so as to form one entity, and the functions of the elements may be performed in the same manner as before being combined.

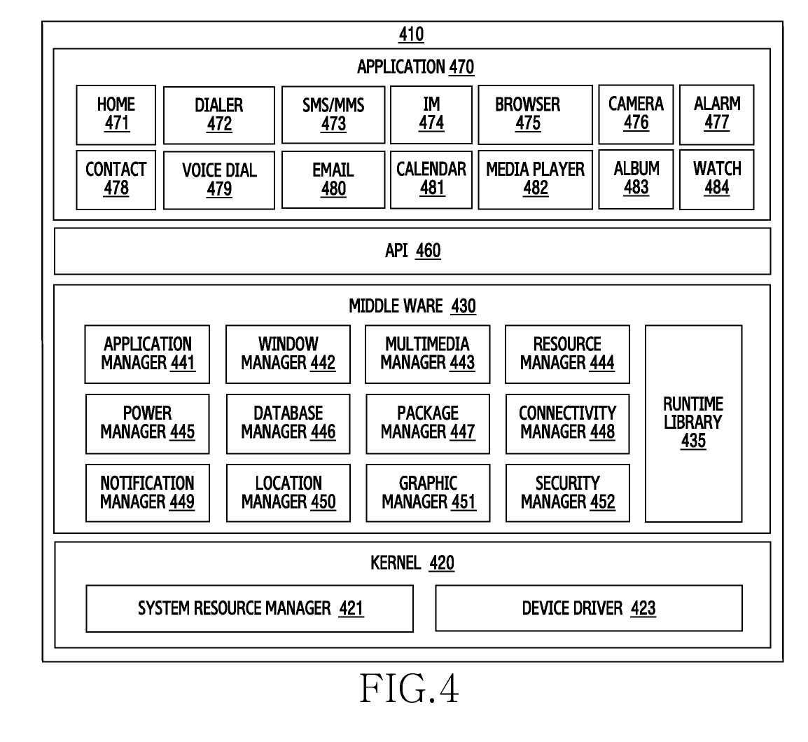

FIG. 4 is a block diagram illustrating an example program module according to various example embodiments. According to an example embodiment, a program module 410 (for example, the program 240 of FIG. 2) may include an OS for controlling resources associated with an electronic device (for example, the electronic device 201) and/or various applications (for example, the application 247 of FIG. 2) driven on the OS. For example, the OS may include, for example, Android™, iOS™, Windows™, Symbian™, Tizen™, Bada™, or the like.

Referring to FIG. 4, the program module 410 may include a kernel 420 (for example, the kernel 241 of FIG. 2), middleware 430 (for example, the middleware 243 of FIG. 2), an API 460 (for example, the API 245 of FIG. 2), and/or an application 470 (for example, the application 247). At least a portion of the program module 410 may be preloaded on the electronic device or downloaded from an external electronic device (for example, the electronic device 202, 204, the server 206, or the like).

The kernel 420 may include, for example, a system resource manager 421 and/or a device driver 423. The system resource manager 421 may control, allocate or collect the system resources. According to an example embodiment, the system resource manager 421 may include a process manager, a memory manager, or a file system manager. The device driver 423 may include, for example, a display driver, a camera driver, a Bluetooth driver, a shared memory driver, a Universal Serial Bus (USB) driver, a keypad driver, a WiFi driver, an audio driver, or an Inter-Process Communication (IPC) driver.

The middleware 430 may provide functions which are commonly required by the application 470 or may provide various functions to the application 470 through the API 460 such that the application 470 can use limited system resources in the electronic device. According to an example embodiment, the middleware 430 may include at least one of a runtime library 435, an application manager 441, a window manager 442, a multimedia manager 443, a resource manager 444, a power manager 445, a database manager 446, a package manager 447, a connectivity manager 448, a notification manager 449, a location manager 450, a graphic manager 451, or a security manager 452.

For example, the runtime library 435 may include a library module which is used by a compiler to add a new function through a programming language while the application 470 is executed. The runtime library 435 may perform input/output management, memory management, an arithmetic function, and the like. The application manager 441 may manage a life cycle of the application 470, for example. The window manager 442 may manage GUI resources used in a screen. The multimedia manager 443 may grasp a format necessary for reproducing media files and may encode or decode the media files by using a Codec suited to the corresponding format. The resource manager 444 may manage a source code of the application 470 or a space of a memory. The power manager 445 may manage a capacity of a battery or a power source, for example, and may provide power information necessary for the operation of the electronic device. According to an example embodiment, the power manager 445 operates along with a basic input/output system (BIOS). The database manager 446 may generate, search, or change a database which is used in the application 470. The package manager 447 may manage installing or updating an application which is distributed in the form of a package file.

The connectivity manager 448 may manage wireless connection, for example. The notification manager 449 may notify the user of an event such as a message arrived, an appointment, a notification of proximity, or the like. The location manager 450 may manage location information of the electronic device. The graphic manager 451 may manage, for example, a graphic effect to be provided to the user or a relevant user interface. The security manager 452 may provide, for example, system security or user authentication. According to an example embodiment, the middleware 430 may include a telephony manager to manage a speech or video telephony function of the electronic device, or a middleware module to form a combination of the various functions of the above-described elements. According to an example embodiment, the middleware 430 may provide a module which is customized according to a kind of an OS. The middleware 430 may dynamically delete a portion of the existing elements or may add new elements. The API 460 may be, for example, a set of API programming functions and may be provided as a different configuration according to an OS. For example, in the case of Android or iOS, a single API set may be provided for each platform. In the case of Tizen, two or more API sets may be provided for each platform.

The application 470 may include, for example, a home 471, a dialer 472, a Short Message Service (SMS)/Multimedia Messaging Service (MIMS) 473, an Instant Message (IM) 474, a browser 475, a camera 476, an alarm 477, contacts 478, a voice dial 479, an email 480, a calendar 481, a media player 482, an album 483, a watch 484. Additionally, or alternatively, although not shown, the application 470 may include, for example, an application for providing health care (for example, measuring exercise or a blood sugar), or environmental information (for example, information on atmospheric pressure, humidity, or temperature). According to an example embodiment, the application 470 may include an information exchanging application for supporting information exchange between the electronic device and an external electronic device. The information exchanging application may include, for example, a notification relay application for relaying specific information to an external electronic device or a device management application for managing an external electronic device. For example, the notification relay application may relay notification information generated in another application of the electronic device to an external electronic device, or may receive notification information from an external electronic device and provide the notification information to the user. The device management application may install, delete, or update, for example, a function (for example, turn-on/turn-off of an external electronic device itself (or a part of components) or adjustment of brightness (or resolution) of a display) of the external electronic device which communicates with the electronic device, or an application running in the external electronic device. According to an example embodiment, the application 470 may include an application (for example, a health care application of a mobile medical device) which is assigned in accordance with an attribute of the external electronic device. According to an example embodiment, the application 470 may include an application which is received from an external electronic device. At least a portion of the program module 410 may be implemented (for example, executed) by software, firmware, hardware (for example, the processor 310 of FIG. 3), or a combination of two or more thereof, and may include modules, programs, routines, sets of instructions, or processes, or the like for performing one or more functions.

According to various example embodiments of the present disclosure, an electronic device may include: a light emission element comprising light emitting circuitry configured to emit light; a first light reception element comprising light receiving circuitry configured to detect an intensity of light reflected from an object based on the light emitted by the light emission element; a second light reception element comprising light receiving circuitry configured to detect a shape of the object using the light reflected from the object based on the light emitted by the light emission element; and a processor. The processor may be configured to: control the light emission element to emit light having an intensity corresponding to an operation mode of the electronic device; and receive light reflected from the object through the first light reception element and/or the second light reception element based on the operation mode of the electronic device.

According to various example embodiments of the present disclosure, the processor may be configured to: when the electronic device is operated in a proximity mode, control the light emission element to emit light having an intensity of a first level; and when the electronic device is operated in an iris recognition mode, control the light emission element to emit light having an intensity of a second level or an intensity of a third level. The intensity of the third level may be greater than the intensity of the second level and the intensity of the first level, and the intensity of the second level may be greater than the intensity of the first level.

According to various example embodiments of the present disclosure, the processor may be configured to: when the electronic device is operated in the iris recognition mode, control the light emission element to emit the light having the intensity of the second level; detect a distance to the object by receiving the light which is emitted from the light emission element and is reflected from the object through the first light reception element; determine whether to perform iris recognition based on the distance to the object; and, upon determination that the iris recognition is performed, control the light emission element to emit the light having the intensity of the third level.

According to various example embodiments of the present disclosure, the processor may be configured to: upon determination that the iris recognition is performed, control the light emission element to emit the light having the intensity of the third level during a first section of an iris recognition period; obtain iris information by receiving light which is emitted from the light emission element and is reflected from the object through the second light reception element, and perform an authentication procedure based on the iris information.

According to various example embodiments of the present disclosure, the processor may be configured to: if authentication based on the iris information fails, determine whether a second section of the iris recognition period arrives; if the second section arrives, control the light emission element to emit the light having the intensity of the second level; detect a distance to the object by receiving light which is emitted from the light emission element and is reflected from the object through the first light reception element; and determine whether to perform iris recognition based on the distance to the object.

According to various example embodiments of the present disclosure, upon determination that the iris recognition is not performed, the processor may be configured to control the light emission element to emit the light having the intensity of the second level.

According to various example embodiments of the present disclosure, the processor may be configured to: detect an intensity of light which is emitted from the light emission element and is reflected from the object based on an amount of light received through the first light reception element during a light emission section of the light emission element, and an amount of light received through the first light reception element during a non-light emission section; and detect the distance to the object based on the intensity of the light which is emitted from the light emission element and is reflected from the object.

According to various example embodiments of the present disclosure, the processor may be configured to determine whether to perform iris recognition based on the distance to the object and a pre-defined safety distance.

According to various example embodiments of the present disclosure, the intensity of the third level may be set based on at least one of the distance to the object and a light emission time of the light emission element.

According to various example embodiments of the present disclosure, when the electronic device is operated in a proximity mode, the processor may be configured to perform control to receive light which is emitted from the light emission element and is reflected from the object through the first light reception element, and to determine proximity or distance of the object based on the intensity of the light received through the first light reception element.

According to various example embodiments of the present disclosure, a portable electronic device may include: a housing including a first surface, a second surface facing a direction opposite the first surface, and a side surface surrounding a space between the first surface and the second surface; a display exposed through a first region of the first surface; a speaker exposed through a second region of the first surface and disposed adjacent to a first border of the display; a light emission element comprising light emitting circuitry exposed through the second region of the first surface and disposed adjacent to the first border of the display; a first light reception element comprising light receiving circuitry exposed through the second region of the first surface, is disposed adjacent to the first border of the display, and having a first resolution; a second light reception element comprising light receiving circuitry exposed through the second region of the first surface, is disposed adjacent to the first border of the display, and having a second resolution higher than the first resolution, the second light reception element being disposed farther away from the light emission element than the first light reception element; a processor electrically or operatively connected to the display, the speaker, the light emission element, the first light reception element, and the second light reception element; and a memory electrically connected with the processor. The memory may store instructions that, when executed, cause the processor to: control the light emission element to generate light of a first level during a first time period; detect at least a part of reflected light of the light of the first level using the first light reception element; control the light emission element to generate light of a second level higher than the first level during a second time period right after the first time period; detect at least a part of reflected light of the light of the second level using the second light reception element; perform biometric recognition using the detected at least part of the reflected light of the light of the second level; and perform authentication based on a result of performing the biometric recognition.

According to various example embodiments, the instructions may cause the processor to determine whether a distance between a target of the biometric recognition and the light emission element falls within a selected reference value (threshold) using the at least part of the reflected light of the light of the first level, and, when the distance falls within the selected reference value, to control the light emission element not to generate the light of the second level or generate the light of the third level lower than the second level during the second time period.

According to various example embodiments, when the distance falls within the selected reference value, the instructions may cause the processor to display a GUI on the display, instructing the target of the biometric recognition to be at a distance from the light emission element by more than the selected reference value.

According to various example embodiments, the speaker may be disposed adjacent to the center of the first border of the display, and the light emission element and the first light reception element may be disposed on one side with reference to the speaker, and the second light reception element may be disposed on the other side with reference to the speaker.

According to various example embodiments, the light emission element may be disposed farther away from the speaker than the first light reception element.

According to various example embodiments, the first region may include a surface comprising a nonmetal material, and the second region may include a surface comprising a metal material.

According to various example embodiments, the housing may include a first plate forming at least a part of the first region of the first surface, a second plate forming at least a part of the second surface, and a side member forming the side surface and the second region of the first surface.

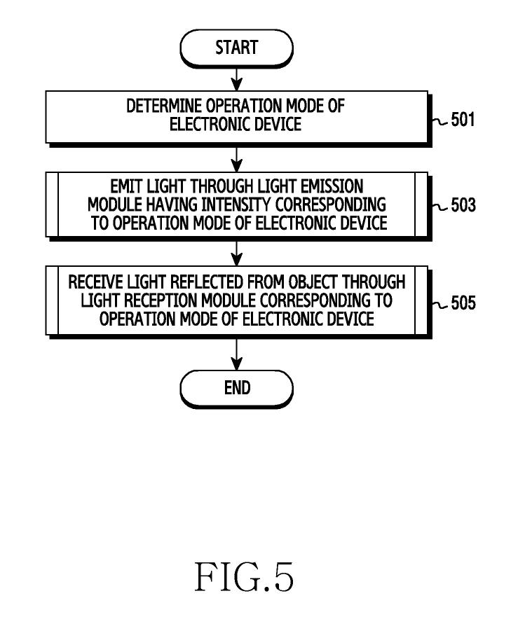

FIG. 5 is a flowchart illustrating an example method of controlling an optical sensor in an electronic device according to various example embodiments of the present disclosure. In the following description, the electronic device may include an entirety or a part (for example, the processor 220) of the electronic device 201 illustrated in FIG. 2A.

Referring to FIG. 5, in operation 501, the electronic device may determine an operation mode of the electronic device. For example, the operation mode of the electronic device 201 may include at least one of a proximity mode, a preparation section of an iris recognition mode, and a recognition section of the iris recognition mode.

In operation 503, the electronic device may emit light through light emission module having intensity corresponding to the operation mode of the electronic device through a light emission module. For example, when the electronic device 201 is operated in the proximity mode, the processor 220 may control the light emission module 280 to emit light with the intensity of the first level. For example, when the electronic device 201 is operated in the iris recognition mode, the processor 220 may control the light emission module 280 to emit light with the intensity of the second level during the preparation section for iris recognition. For example, when the electronic device 201 is operated in the iris recognition mode, the processor 220 may control the light emission module 280 to emit light with the intensity of the third level during the iris recognition section.

In operation 505, the electronic device may receive light reflected from an object through a light reception module corresponding to the operation mode of the electronic device. For example, when the electronic device 201 is operated in the proximity mode, the processor 220 may activate the light reception module 290 corresponding to the proximity sensor to receive light reflected from the object. In this case, the processor 220 may determine the proximity or distance of the object to the electronic device 201 based on an amount of received light reflected from the object, which is obtained through the light reception module 290 corresponding to the proximity sensor. For example, when the electronic device 201 is operated in the iris recognition mode, the processor 220 may activate the light reception module 290 corresponding to the proximity sensor to receive light reflected from the object during the preparation section for iris recognition. In this case, the processor 220 may estimate a distance between the electronic device 201 and the object based on the amount of received light reflected from the object, which is obtained through the light reception module 290 corresponding to the proximity sensor. For example, when the electronic device 201 is operated in the iris recognition mode, the processor 220 may activate the light reception module 290 corresponding to the iris sensor to receive light reflected from the object during the iris recognition section. In this case, the processor 220 may perform iris recognition on the user based on iris information corresponding to the light reflected from the object, which is received through the light reception module 290 corresponding to the iris sensor.

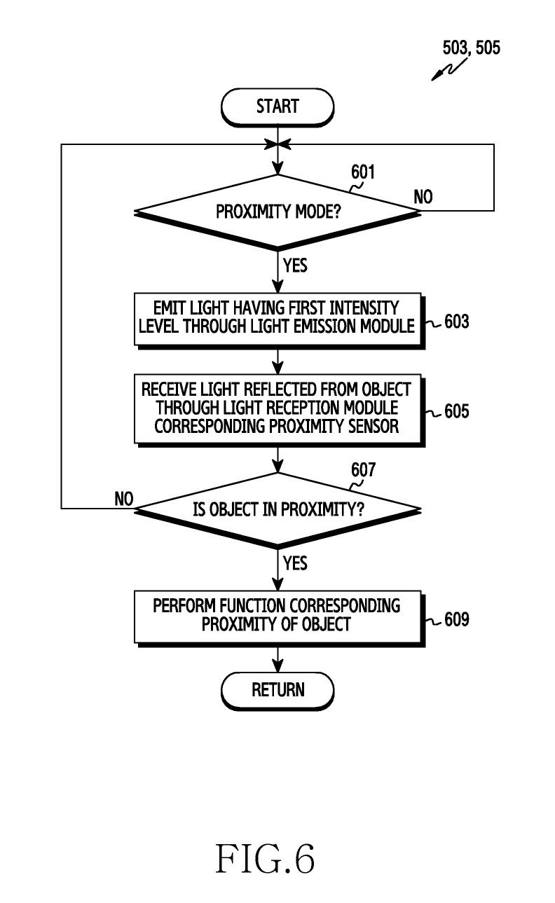

FIG. 6 is a flowchart illustrating an example method of controlling a proximity sensor in an electronic device according to various example embodiments of the present disclosure. In the following description, operations 503 and 505 in FIG. 5 of emitting light based on an operation of the electronic device and receiving light reflected from an object will be described in greater detail. In the following description, the electronic device may include an entirety or a part (for example, the processor 220) of the electronic device 201 illustrated in FIG. 2A.

Referring to FIG. 6, when the electronic device determines an operation mode of the electronic device (for example, operation 501 of FIG. 5), the electronic device may determine whether the electronic device is operated in the proximity mode or not in operation 601. For example, the processor 220 may determine whether the proximity mode is activated based on a characteristic (for example, a type) of an application driven in the electronic device 201. For example, when a voice communication application is driven in the electronic device 201, the processor 220 may determine that the proximity mode is activated.

When the operation mode of the electronic device is the proximity mode, the electronic device may emit light having the intensity of the first level through a light emission module of the electronic device in operation 603. For example, the processor 220 may adjust the light emission intensity of the light emission module 280 to the first level by reducing a current by increasing a resistance value of the variable resistance 284 of the light emission module 280. For example, the processor 220 may adjust the light emission intensity of the light emission module 280 to the first level by adjusting power of the light emission module 280 to power corresponding to the first level.

In operation 605, the electronic device may receive light reflected from the object using a light reception module corresponding to the proximity sensor. For example, the light emission module 280 may switch between an activation (ON) state and an inactivation (OFF) state in a predetermined cycle. Accordingly, the light reception module 290 may detect an amount of received light in a light emission section in which the light emission module 280 is activated, and an amount of received light in a non-light emission section in which the light emission module 280 is inactivated.

In operation 607, the electronic device may determine the proximity or distance of the object based on the amount of received light reflected from the object, which is received through the light reception module corresponding to the proximity sensor. For example, the processor 220 may detect the amount of received light reflected from the object by removing a noise caused by light emission of an external light emission substance (for example, the sun, a fluorescent lamp) or the light emission module 280 by deducting the amount of received light in the non-light emission section from the amount of received light in the light emission section. For example, the processor 220 may determine the proximity or distance of the object based on a ratio between the amount of light emitted from the light emission module 280 (for example, the light emission intensity of the first level) and the amount of received light reflected from the object. In this case, when the ratio of the amount of received light reflected from the object to the amount of light emitted from the light emission module 280 exceeds a reference ratio, the processor 220 may determine that the corresponding object is close to the electronic device 201. For example, the processor 220 may determine the proximity or distance of the object by comparing the amount of received light reflected from the object and a pre-defined reference amount of received light. In this case, when the amount of received light reflected from the object exceeds the reference amount of received light, the processor 200 may determine that the corresponding object is close to the electronic device 201.

When it is determined that the object is not close to the electronic device, the electronic device may resume operation 601 to determine whether the electronic device is operated in the proximity mode.

When it is determined that the object is close to the electronic device, the electronic device may perform a function corresponding to the proximity of the object in operation 609. For example, when it is determined that the object is close to the electronic device 201 while a voice communication application is being driven, the processor 220 may control the display 260 to be inactivated.

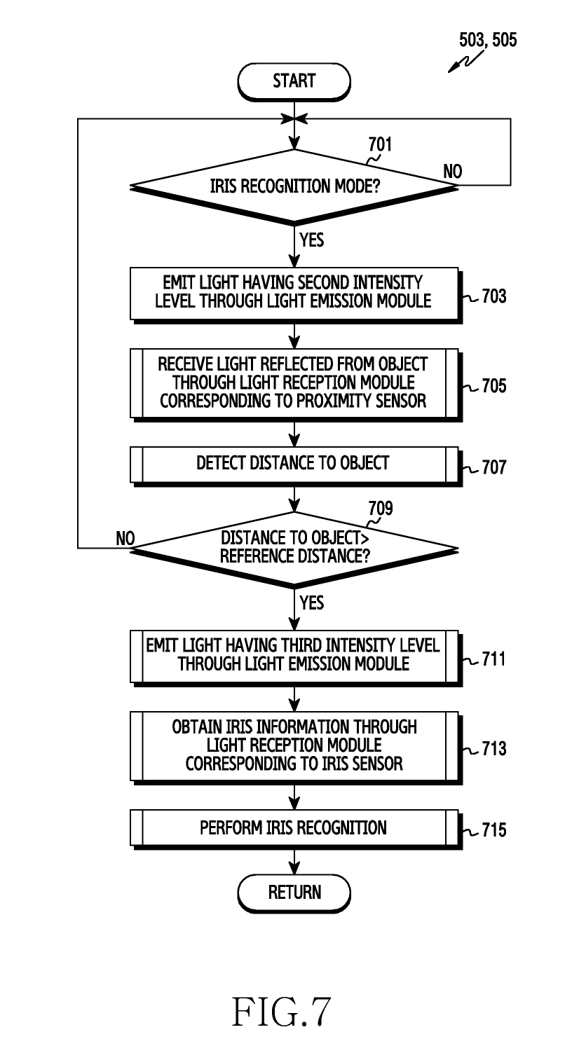

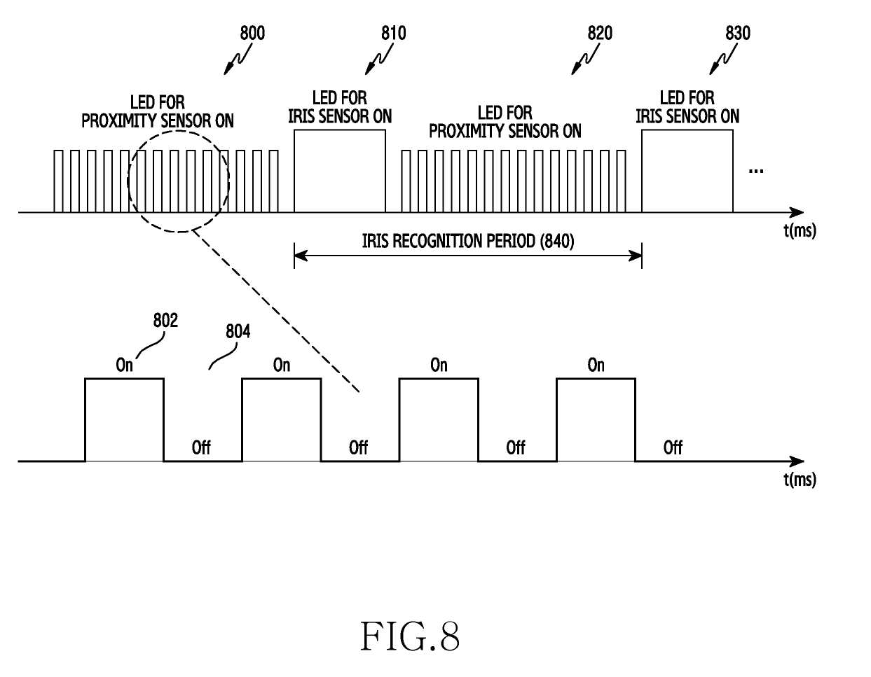

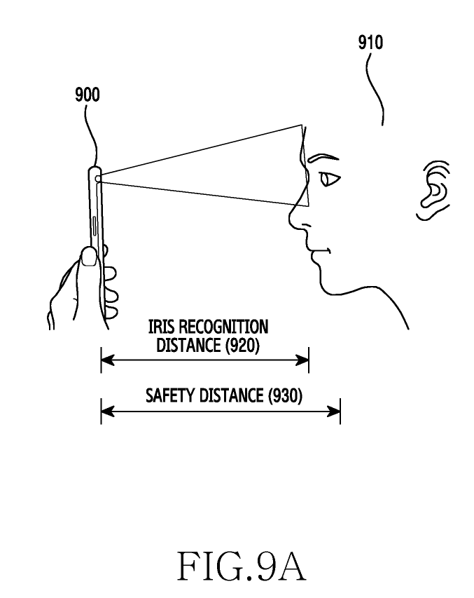

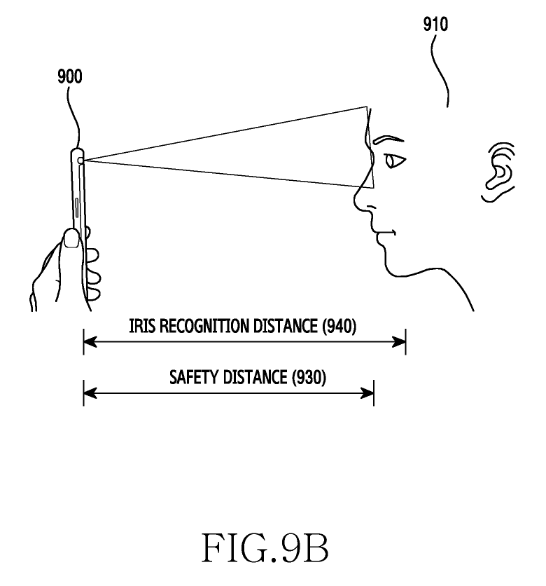

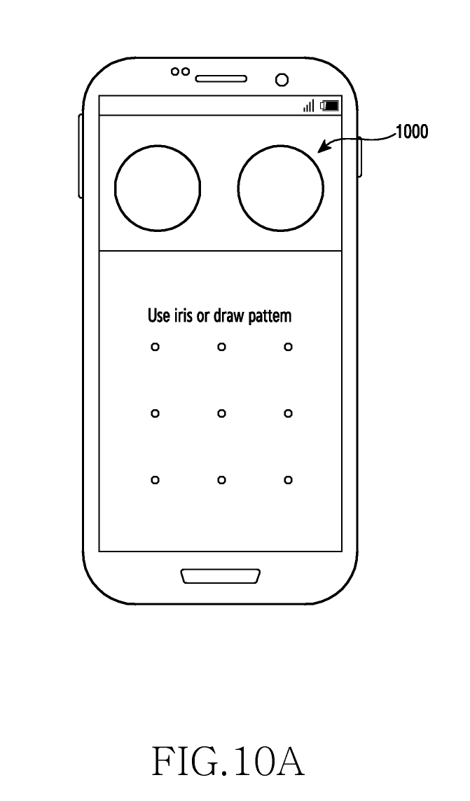

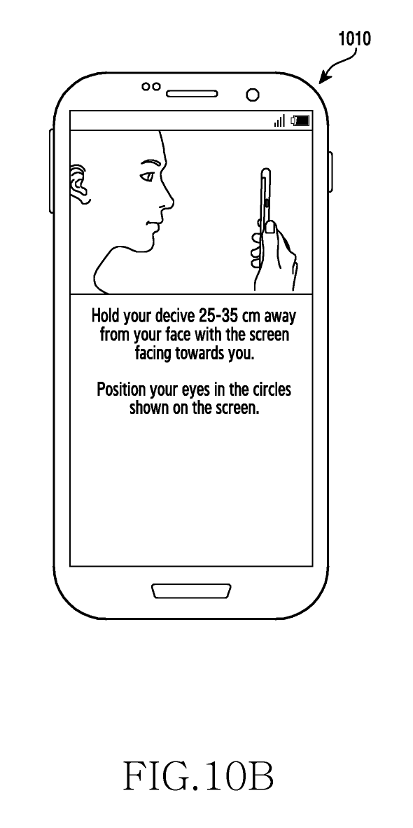

FIG. 7 is a flowchart illustrating an example method of controlling an iris sensor in an electronic device according to various example embodiments of the present disclosure. FIG. 8 is a diagram illustrating example light emission intensity of a light emission module for iris recognition in an electronic device according to various example embodiments of the present disclosure. FIGS. 9A and 9B are diagrams illustrating example distance configurations between an electronic device and a user for iris recognition according to various embodiments of the present disclosure. FIGS. 10A and 10B are diagrams illustrating example screen configurations for iris recognition in an electronic device according to various example embodiments of the present disclosure. In the following description, operations 503 and 505 in FIG. 5 of emitting light based an operation mode of the electronic device and receiving light reflected from the object will be described in greater detail. In the following description, the electronic device may include an entirety or a part (for example, the processor 220) of the electronic device 201 illustrated in FIG. 2A.

Referring to FIG. 7, when the electronic device determines an operation mode of the electronic device (for example, operation 501 of FIG. 5), the electronic device may determine whether the electronic device is operated in the iris recognition mode in operation 701. For example, the processor 220 may determine whether the iris recognition mode for user authentication is activated based on a user input or a characteristic (for example, a type) of an application driven in the electronic device 201.

When the electronic device is operated in the iris recognition mode, the electronic device may emit light having the intensity of the second level through a light emission module of the electronic device in operation 703. For example, when the operation mode of the electronic device 201 is changed to the iris recognition mode, the processor 220 may determine a preparation section of the iris recognition mode for determining whether it is possible to recognize a user's iris. Accordingly, as shown in FIG. 8, the processor 220 may control the light emission module 280 to emit light with the intensity of the second level in order to determine whether the user for iris recognition is positioned in a safety distance (800 in FIG. 8).

In operation 705, the electronic device may receive light reflected from the object using a light reception module corresponding to the proximity sensor. For example, as shown in FIG. 8, the light reception module 290 corresponding to the proximity sensor may detect an amount of received light in a light emission section 802 in which the light emission module 280 is activated, and an amount of received light in a non-light emission section 804 in which the light emission module 280 is inactivated.

In operation 707, the electronic device may detect a distance between the electronic device and the object based on light reflected from the object, which is received through the light reception module corresponding to the proximity sensor. For example, the processor 220 may recognize the amount of received light in the non-light emission section 804 in which the light emission module 280 is inactivated as a noise. Accordingly, the processor 220 may detect the amount of received light reflected from the object by deducting the amount of received light in the non-light emission section 804 from the amount of received light in the light emission section 802. The processor 220 may estimate the distance between the electronic device 201 and the object based on the amount of received light reflected from the object.

In operation 709, the electronic device may determine whether the distance between the electronic device and the object exceeds a reference distance. For example, the reference distance is a distance that meets safety regulations for iris recognition, and may be determined based on a light emission intensity and a light emission time of the light emission module 280.

When the distance between the electronic device and the object is shorter than or equal to the reference distance, the electronic device may determine that it is not possible to perform iris recognition. For example, when a distance 920 between an electronic device 900 and a user 910 for iris recognition is shorter than a safety distance 930 as illustrated in FIG. 9A, the processor 220 may determine that light emitted from the light emission module 280 to recognize the iris harmfully influences user's eyes, and may put a limit to recognizing the iris. In this case, the processor 220 may control the display 260 to display a guidance message 1010 to advise the user to hold the electronic device away from the user as illustrated in FIG. 10B.

When the distance between the electronic device and the object exceeds the reference distance, the electronic device may emit light having the intensity of the third level through the light emission module of the electronic device in order to recognize the iris in operation 711. For example, when a distance 940 between the electronic device 900 and the user 910 for iris recognition is longer than the safety distance 930 as illustrated in FIG. 9B, the processor 220 may determine that it is possible to recognize the iris. Accordingly, the processor 220 may control the light emission module 280 to emit light with the intensity of the third level in order to perform iris recognition as illustrated in FIG. 8 (810). In this case, the processor 220 may control the display 260 to display an iris recognition screen 1000 indicating positions of eyes to recognize the iris as illustrated in FIG. 10A. For example, the intensity of the third level may be changed to correspond to the distance between the electronic device 201 and the object.

In operation 713, the electronic device may obtain iris information of the user by receiving light reflected from the object using a light reception module corresponding to the iris sensor. For example, the light reception module 290 corresponding to the iris sensor may obtain a shape (for example, an image) of the object (for example, the iris) by receiving light which is reflected from the object by light emission of the light emission module 280.

In operation 715, the electronic device may perform iris recognition based on the user's iris information. For example, the processor 220 may determine whether it is possible to authenticate the user by comparing the user's iris information which is obtained by receiving light reflected from the object and reference iris information pre-stored in the memory 230. For example, when the user is authenticated based on the user's iris information on a lock screen of the electronic device 201 as illustrated in FIG. 10A, the processor 220 may unlock the electronic device 201.

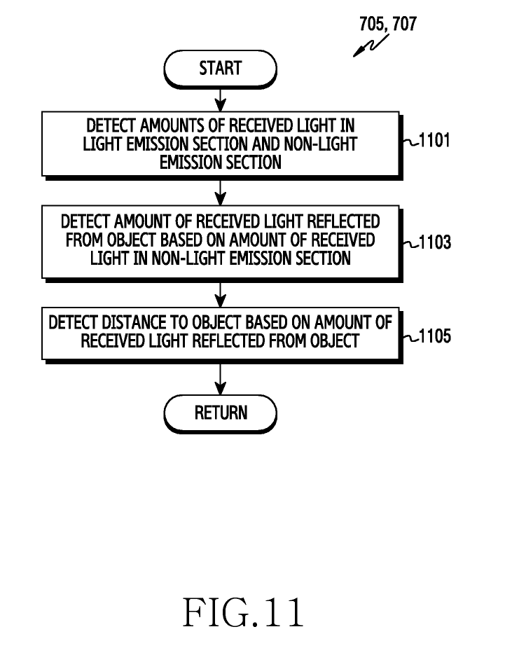

FIG. 11 is a flowchart illustrating an example method of measuring a distance to a user in an electronic device according to various example embodiments of the present disclosure. In the following description, operations 705 and 707 in FIG. 7 of detecting a distance between an electronic device and an object will be described in greater detail. In the following description, the electronic device may include an entirety or a part (for example, the processor 220) of the electronic device 201 illustrated in FIG. 2A.

Referring to FIG. 11, when the light emission module of the electronic device emits light with the intensity of the second level (for example, operation 703 of FIG. 7), in operation 1101, the electronic device may detect, through the light reception module corresponding to the proximity sensor, an amount of received light in the light emission section in which the light emission module is activated, and an amount of received light in the non-light emission section in which the light emission module is inactivated.

In operation 1103, the electronic device may detect an amount of received light reflected from the object using the amount of received light in the light emission section and the amount of received light in the non-light emission section. For example, the light reception module 290 corresponding to the proximity sensor may receive light reflected from the object by light emission of the light emission module 280 with light generated by external light. The processor 220 may determine to receive light reflected from the object with light generated by external light through the light reception module 290 during the light emission section of the light emission module 280, and to receive light generated by external light during the non-light emission section. Accordingly, the processor 220 may detect the amount of received light reflected from the object by deducting the amount of received light in the non-light emission section from the amount of received light in the light emission section.

In operation 1105, the electronic device may detect the distance to the object based on the amount of received light reflected from the object. For example, the processor 220 may detect a difference between the amount of emitted light (for example, the light emission intensity of the second level) of the light emission module 280 and the amount of received light reflected from the object. The processor 220 may detect the distance between the electronic device 201 and the object based on the difference between the amount of emitted light of the light emission module 280 and the amount of received light reflected from the object, and a reference variation in the amount of received light per unit distance (for example, 1 cm). For example, the processor 220 may extract distance information corresponding the amount of received light reflected from the object from a distance information table stored in the memory 230. The processor 220 may recognize the distance between the electronic device 201 and the object based on the distance information corresponding to the amount of received light reflected from the object.

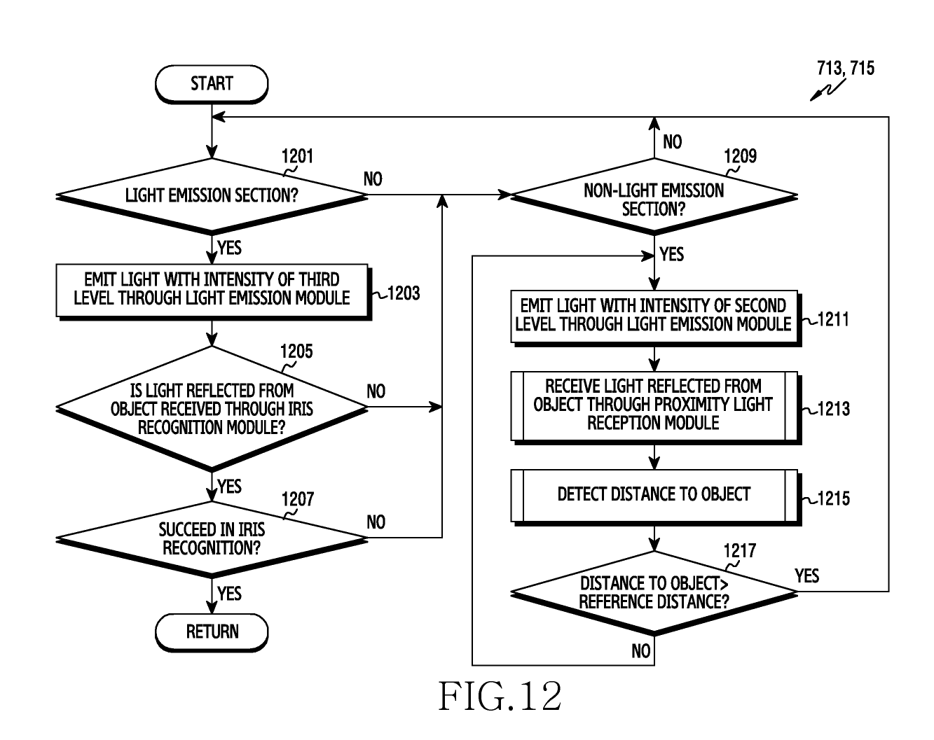

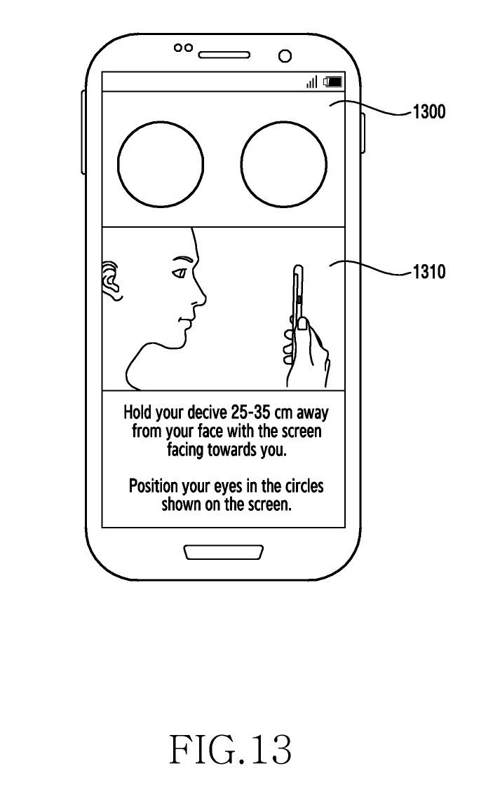

FIG. 12 is a flowchart illustrating an example method of recognizing an iris in an electronic device according to various example embodiments of the present disclosure. FIG. 13 is a diagram illustrating an example screen configuration for recognizing an iris in an electronic device according to various example embodiments of the present disclosure. In the following description, operations 713 to 715 in FIG. 7 of performing iris recognition will be described in greater detail. In the following description, the electronic device may include an entirety or a part (for example, the processor 220) of the electronic device 201 illustrated in FIG. 2A.

Referring to FIG. 12, in operation 1201, the electronic device may determine whether the electronic device is in a light emission section in which light with the intensity of the third level is emitted through the light emission module to recognize an iris. For example, the processor 220 may perform operations during the iris recognition period, that is, collecting light through the light reception module 290 corresponding to the iris sensor, obtaining iris information, and determining whether the user is authenticated. Accordingly, the light emission module 280 may not continuously emit light during the iris recognition period, and emit light with the intensity of the third level only during the light emission section of the iris recognition period.

When the light emission section of the light emission module arrives, the electronic device may emit light with the intensity of the third level to recognize the iris through the light emission module in operation 1203. For example, the intensity of the third level may be pre-defined or may be varied based on a distance between the electronic device 201 and the object.

In operation 1205, the electronic device may determine whether light reflected from the object is received through the light reception module corresponding to the iris sensor. For example, when a difference between the amount of received light in the light emission section of the light emission module 280 and the amount of received light in the non-light emission section is smaller than a reference value, the processor 220 may determine that light reflected from the object is not received.

When the light reflected from the object is not received through the light reception module corresponding to the iris sensor, the electronic device may determine that the user for iris recognition is distanced from the electronic device 201 by more than a distance in which the iris can be recognized. Accordingly, the electronic device may determine whether the non-light emission section (preparation section) of the light emission module arrives in operation 1209.

When the light reflected from the object is received through the light reception module corresponding to the iris sensor, the electronic device may determine whether the electronic device succeeds in recognizing the user's iris in operation 1207. For example, the processor 220 may obtain iris information based on the light reflected from the object, which is received through the light reception module 290 corresponding to the iris sensor. When the iris information obtained based on the light reflected from the object is included in an authentication list, the processor 220 may determine that the electronic device succeeds in recognizing the user's iris.

When the light reflected from the object is not received through the light reception module corresponding to the iris sensor or the electronic device fails to recognize the iris, the electronic device may determine whether the non-light emission section (preparation section) of the light emission module arrives or not in operation 1209.

When the non-light emission section of the light emission module does not arrive, the electronic device may resume operation 1201 to determine whether the electronic device is in the light emission section of the light emission module.

When the non-light emission section of the light emission module arrives, the electronic device may emit light with the intensity of the second level through the light emission module in order to determine whether the user is positioned in a safety distance in operation 1211. For example, the processor 220 may control the light emission module 280 to emit light with the intensity of the second level in order to determine whether the user is positioned in the safety distance during the non-light emission section 820 of the light emission module 280 in the iris recognition period 840 as illustrated in FIG. 8.

In operation 1213, the electronic device may receive light reflected from the object through the light reception module corresponding to the proximity sensor. For example, the processor 220 may control the light reception module 290 corresponding to the proximity sensor to receive light reflected from the object during the non-light emission section 820 of the light emission module 280.

In operation 1215, the electronic device may detect a distance between the electronic device and the object (user) based on the light reflected from the object, which is received using the light reception module corresponding to the proximity sensor. For example, the processor 220 may detect the amount of received light reflected from the object by removing a noise caused by an external light emission substance from the amount of light received through the light reception module 290 corresponding to the proximity sensor. The processor 220 may estimate the distance between the electronic device 201 and the object based on the amount of received light reflected from the object.

In operation 1217, the electronic device may determine whether the distance between the electronic device and the object exceeds a reference distance.

When the distance between the electronic device and the object exceeds the reference distance, the electronic device may resume operation 1201 to determine whether the light emission section of the light emission module arrives. For example, when it is determined that the distance to the user satisfies the safety distance during the non-light emission section 820 of the light emission module 280 as shown in FIG. 8, the processor 220 may determine that it is possible to recognize the user's iris. Accordingly, the processor 220 may determine whether the light emission section 830 of the light emission module 280 arrives again.

When the distance between the electronic device and the object is shorter than or equal to the reference distance, the electronic device may determine that the user is positioned in a distance closer than the safety distance for iris recognition, and may put a limit to performing iris recognition. In this case, the processor 220 may control the display 260 to display a guidance message 1310 for advising the user to hold the electronic device away from the user on a region different from the screen configuration 1300 for iris recognition as illustrated in FIG. 13.

When it is determined that the user is positioned in the distance closer to the electronic device than the safety distance for iris recognition, the electronic device may resume operation 1211 to emit light with the intensity of the second level through the light emission module in order to determine whether the user is positioned in the safety distance.

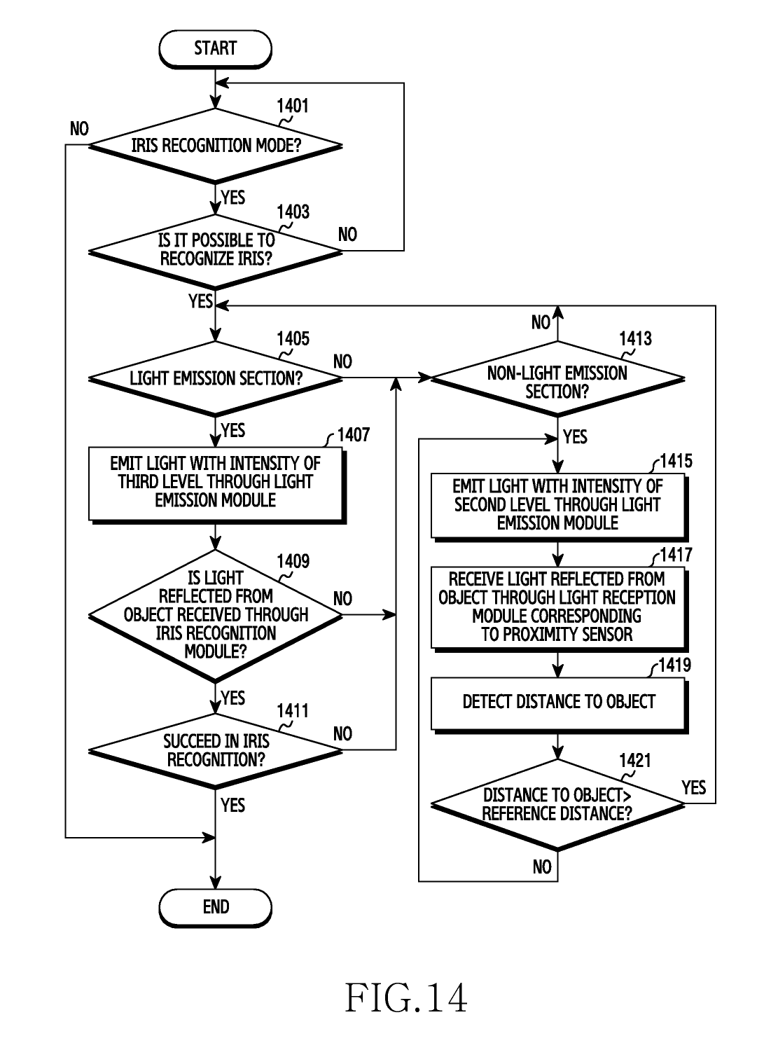

FIG. 14 is a flowchart illustrating an example method for recognizing an iris in an electronic device according to various example embodiments of the present disclosure. In the following description, the electronic device may include an entirety or a part (for example, the processor 220) of the electronic device 201 illustrated in FIG. 2A.

Referring to FIG. 14, in operation 1401, the electronic device may determine whether the electronic device is operated in a mode for iris recognition. For example, the processor 220 may determine whether an application for iris recognition is executed based on a user input.

When the electronic device is operated in the mode for iris recognition, the electronic device may determine whether it is possible to recognize an iris based on a distance to an object for iris recognition in operation 1403. For example, when the mode for iris recognition is activated in the electronic device 201, the processor 220 may emit light with the intensity of the second level through the light emission module 280. The processor 220 may control the light reception module 290 (for example, a first light reception module) corresponding to the proximity sensor to receive light reflected from the object. The processor 220 may detect a distance between the electronic device 210 and the object for iris recognition based on the amount of received light which is collected through the light reception module 290 corresponding to the proximity sensor. When the distance to the object for iris recognition exceeds a reference distance, the processor 220 may determine that it is possible to perform iris recognition with respect to the corresponding object.

When it is possible to recognize the iris, the electronic device may determine whether a light emission section in which light with the intensity of the third level is emitted through the light emission module to recognize the iris arrives in operation 1405. For example, the processor 220 may determine whether a light emission section in which light with an intensity for iris recognition is emitted in the iris recognition period arrives.

When the light emission section of the light emission module arrives, the electronic device may emit light with the intensity of the third level for recognizing the iris through the light emission module in operation 1407. For example, when the light emission section 810 arrives as illustrated in FIG. 8, the light emission module 280 may emit light with the intensity of the third level.

In operation 1409, the electronic device may determine whether light reflected from the object is received through the light reception module (iris recognition module) corresponding to the iris sensor. For example, the processor 220 may determine whether reflected light with an intensity greater than or equal to a reference intensity is received through the light reception module 290 for iris recognition. For example, when the intensity of light received through the light reception module 290 for iris recognition is smaller than the reference intensity, the processor 220 may determine that light reflected from the object is not received.

When the light reflected from the object is not received through the light reception module corresponding to the iris sensor, the electronic device may determine that it is impossible to perform iris recognition with respect to the object (user). Accordingly, the electronic device may determine whether a non-light emission section (preparation section) of the light emission module arrives in operation 1413.

When the light reflected from the object is received through the light reception module corresponding to the iris sensor, the electronic device may determine whether the electronic device succeeds in recognizing the iris on the corresponding object (for example, the user) in operation 1411. For example, the processor 220 may perform iris recognition with respect to the corresponding object (for example, the user) based on iris information corresponding to the light reflected from the object.

When the light reflected from the object is not received through the light reception module corresponding to the iris sensor or the electronic device fails to recognize the iris, the electronic device may determine whether the non-light emission section (preparation section) of the light emission module arrives in operation 1413. Herein, the non-light emission section may include a section in which the light emission module 280 does not emit the light with the intensity of the third level for iris recognition while the electronic device 201 is being operated in the mode for iris recognition.

When the non-light emission section of the light emission module arrives in operation 1413, the electronic device may emit light with the intensity of the second level through the light emission module in order to detect a distance to the object (user) for iris recognition in operation 1415. For example, the processor 220 may control the light emission module 280 to emit light with the intensity of the second level in order to detect the distance between the user for iris recognition and the electronic device 201 during the non-light emission section 820 of the light emission module 280 in the iris recognition period 840 as illustrated in FIG. 8.

In operation 1417, the electronic device may receive light reflected from the object through the light reception module corresponding to the proximity sensor during the operation in the iris recognition mode. For example, the processor 220 may activate the light reception module 290 (for example, a first light reception module) corresponding to the proximity sensor during the non-light emission section 820 of the light emission module 290 in order to detect the distance to the object (user) for iris recognition.

In operation 1419, the electronic device may detect a distance between the electronic device and the object (user) based on light reflected from the object, which is received using the light reception module corresponding to the proximity sensor. For example, the processor 220 may estimate the distance to the object for iris recognition based on the amount of light received through the light reception module 290 corresponding to the proximity sensor. For example, the processor 220 may estimate the distance to the object for iris recognition based on the amount of light received through the light reception module 290 corresponding to the proximity sensor, and a light emission time of the light emission module 290 and a light reception time of the light reception module 290.

In operation 1421, the electronic device may determine when the distance between the electronic device and the object for iris recognition exceeds a reference distance.

When the distance to the object for iris recognition exceeds the reference distance, the electronic device may resume operation 1405 to determine whether the light emission section of the light emission module arrives.

When the distance to the object for iris recognition is shorter than or equal to the reference distance, the electronic device may determine that a safety distance to the object for iris recognition is not guaranteed, and may put a limit to performing iris recognition. In this case, the processor 220 may control the display 260 to display a message advising the user to be distanced from the electronic device 201 in order to recognize the iris.

When it is determined that the safety distance to the object for iris recognition is not guaranteed, the electronic device may resume operation 1415 to emit light with the intensity of the second level through the light emission module in order to determine whether the safety distance to the object for iris recognition is guaranteed.

According to various embodiments of the present disclosure, the electronic device 201 may determine whether it is possible to recognize the iris based on the distance to the object for iris recognition at a time when the light emission section of the light emission module 280 arrives. For example, the electronic device 201 may determine whether it is possible to perform iris recognition with respect to the corresponding object based on the distance to the object for iris recognition, which is detected during the non-light emission section, at the time when the light emission section arrives. When it is determined that the safety distance to the object for iris recognition is not guaranteed during the light emission section, the electronic device 201 may continuously or periodically detect the distance to the object for iris recognition, and determine whether it is possible to recognize the iris.

According to various example embodiments of the present disclosure, a method for operating of an electronic device may include: emitting light of an intensity corresponding to an operation mode of the electronic device through a light emission element of the electronic device; and receiving light which is reflected from an object through a first light reception element and/or a second light reception element of the electronic device based on the operation mode of the electronic device. The first light reception element may be configured to detect an intensity of light which is reflected from the object based on the light emitted by the light emission element, and the second light reception element may be configured to detect a shape of the object using the light which is reflected from the object based on the light emitted by the light emission element.

According to various example embodiments, emitting the light may include: when the electronic device is operated in a proximity mode, emitting light with an intensity of a first level through the light emission element; and, when the electronic device is operated in an iris recognition mode, emitting light with an intensity of a second level or an intensity of a third level through the light emission element. The intensity of the third level may be greater than the intensity of the second level and the intensity of the first level, and the intensity of the second level may be greater than the intensity of the first level.

According to various example embodiments, receiving the light may include: when the electronic device is operated in the iris recognition mode, receiving, through the first light reception element, light which is emitted from the light emission element with the intensity of the second level, and is reflected from the object; detecting a distance to the object based on the intensity of the light which is reflected from the object; determining whether to perform iris recognition based on the distance to the object; and upon determination that the iris recognition is performed, emitting the light with the intensity of the third level through the light emission element.

According to various example embodiments, the method may further include: upon determination that the iris recognition is performed, emitting the light with the intensity of the third level through the light emission element during a first section of an iris recognition period; obtaining iris information based on light emitted from the light emission element and reflected from the object, which is received through the second light reception element; and performing an authentication procedure based on the iris information.

According to various example embodiments, the method may further include: if authentication based on the iris information fails, determining whether a second section of the iris recognition period arrives; if the second section arrives, emitting the light with the intensity of the second level through the light emission element; receiving light which is emitted from the light emission element and is reflected from the object through the first light reception element; and detecting a distance to the object based on an intensity of the light reflected from the object; and determining whether to perform iris recognition based on the distance to the object.

According to various example embodiments, the method may further include, when it is determined that the iris recognition is not performed, emitting the light with the intensity of the second level through the light emission element.

According to various example embodiments, detecting the distance to the object may include: detecting an intensity of light which is emitted from the light emission element and is reflected from the object based on an amount of light received through the first light reception element during a light emission section of the light emission element, and an amount of light received through the first light reception element during a non-light emission section; and detecting the distance to the object based on the intensity of the light which is emitted from the light emission element and is reflected from the object.

According to various example embodiments, determining whether to perform the iris recognition may include determining whether to perform the iris recognition based on the distance to the object and a pre-defined safety distance.

According to various example embodiments, the intensity of the third level may be set based on at least one of the distance to the object and a light emission time of the light emission element.

According to various example embodiments, receiving the light may include, when the electronic device is operated in a proximity mode, receiving light which is emitted from the light emission element and is reflected from the object through the first light reception element, and receiving the light may further include determining proximity or distance of the object based on the intensity of the light received through the first light reception element.

The electronic device and the operation method thereof according to various example embodiments may adjust a light emission intensity of the light emission element to correspond to an operation mode of the electronic device, and perform iris recognition based on a distance to the user for iris recognition, which is measured by functionally interworking with the proximity sensor and the iris sensor, such that eye fatigue of the user on iris recognition can be reduced, and usability of iris recognition can be enhanced.

The electronic device and the operation method thereof according to various example embodiments determine the proximity or distance of the user and perform iris recognition using one light emission element which adjusts a light emission intensity to correspond to an operation mode of the electronic device, such that the number of holes exposed to the outside can be reduced in the electronic device.

A term “module” used in the present document includes a unit comprising hardware, software, or firmware, or any combination thereof and may be interchangeably used with a term such as a unit, a logic, a logical block, a component, a circuit, and the like. The “module” may be an integrally constructed component or a minimum unit or one part thereof for performing one or more functions. The “module” may be mechanically or electrically implemented, and may include, for example, and without limitation, a dedicated processor, a CPU, an Application-Specific Integrated Circuit (ASIC) chip, a Field-Programmable Gate Arrays (FPGAs), or a programmable-logic device, which is known or to be developed to perform certain operations.

At least one part of an apparatus (e.g., modules or functions thereof) or method (e.g., operations) according to various example embodiments may be implemented with an instruction stored in a computer-readable storage media (e.g., the memory 230). If the instruction is executed by one or more processors (e.g., the processor 220), the one or more processors may perform a function corresponding to the instruction. The computer-readable storage media may include a hard disk, a floppy disk, magnetic media (e.g., a magnetic tape), optical media (e.g., a Compact Disc-ROM (CD-ROM), a Digital Versatile Disc (DVD), magnetic-optic media (e.g., a floptical disk)), an internal memory, or the like. The instruction may include a code created by a compiler or a code executable by an interpreter. The module or programming module according to various example embodiments may further include at least one or more constitutional elements among the aforementioned constitutional elements, or may omit some of them, or may further include additional other constitutional elements.

According to various example embodiments, operations performed by a module, programming module, or other elements may be executed in a sequential, parallel, repetitive, or heuristic manner. At least some of the operations may be executed in a different order or may be omitted, or other operations may be added.

In addition, various example embodiments included in the present disclosure are provided for explaining and understanding technical features, not for limiting the scope of the present disclosure. Therefore, all changes based on the technical features of the present disclosure or various other example embodiments will be understood as being included in the scope of the present disclosure.

What is claimed is:

1. An electronic device comprising:
a light emission element comprising light emitting circuitry configured to emit light;
a first light reception element comprising light receiving circuitry configured to detect an intensity of light reflected from an object based on the light emitted by the light emission element;
a second light reception element comprising light receiving circuitry configured to detect a shape of the object using the light reflected from the object based on the light emitted by the light emission element; and
a processor configured to:
control the light emission element to emit light having an intensity corresponding to an operation mode of the electronic device; and
receive light reflected from the object via at least one of the first light reception element or the second light reception element based on the operation mode of the electronic device.

2. The electronic device of claim 1, wherein the processor is configured to:
control the light emission element to emit light having an intensity of a first level when the electronic device is operated in a proximity mode; and
control the light emission element to emit light having an intensity of a second level or an intensity of a third level when the electronic device is operated in an iris recognition mode,
wherein the intensity of the third level is greater than the intensity of the second level and the intensity of the first level, and
wherein the intensity of the second level is greater than the intensity of the first level.

3. The electronic device of claim 2, wherein the processor is configured to:
control the light emission element to emit the light having the intensity of the second level when the electronic device is operated in the iris recognition mode;
detect a distance to the object by receiving the light reflected from the object via the first light reception element;
determine whether to perform iris recognition based on the distance to the object; and
control the light emission element to emit the light having the intensity of the third level upon determination that the iris recognition is performed.

4. The electronic device of claim 3, wherein the processor is configured to:
control the light emission element to emit the light having the intensity of the third level during a first section of an iris recognition period upon determination that the iris recognition is performed;
obtain iris information by receiving light reflected from the object via the second light reception element, and
perform an authentication procedure based on the iris information.

5. The electronic device of claim 4, wherein the processor is configured to:
determine whether a second section of the iris recognition period arrives if authentication based on the iris information fails;
control the light emission element to emit the light having the intensity of the second level if the second section of the iris recognition period arrives;
detect a distance to the object by receiving light reflected from the object via the first light reception element; and
determine whether to perform iris recognition based on the distance to the object.

6. The electronic device of claim 3, wherein, the processor is configured to control the light emission element to emit the light having the intensity of the second level upon determination that the iris recognition is not performed.

7. The electronic device of claim 3, wherein the processor is configured to:
detect an intensity of light reflected from the object based on an amount of light received via the first light reception element during a light emission section of the light emission element and an amount of light received via the first light reception element during a non-light emission section of the light emission element; and
detect the distance to the object based on the intensity of the light is reflected from the object.

8. The electronic device of claim 3, wherein the processor is configured to determine whether to perform iris recognition based on the distance to the object and a pre-defined safety distance.

9. The electronic device of claim 2, wherein the intensity of the third level is set based on at least one of: the distance to the object or a light emission time of the light emission element.

10. The electronic device of claim 1, wherein, the processor is configured to control to receive light is reflected from the object via the first light reception element, when the electronic device is operated in a proximity mode, and
wherein the processor is configured to determine proximity of the object based on the intensity of the light received via the first light reception element.

11. A method of operating of an electronic device, the method comprising:
emitting light having an intensity corresponding to an operation mode of the electronic device via a light emission element of the electronic device; and
receiving light which is reflected from an object via at least one a first light reception element or a second light reception element of the electronic device based on the operation mode of the electronic device,
wherein the first light reception element is configured to detect an intensity of light which is reflected from the object based on the light emitted by the light emission element, and
wherein the second light reception element is configured to detect a shape of the object using the light which is reflected from the object based on the light emitted by the light emission element.

12. The method of claim 11, wherein emitting the light comprises:
emitting light having an intensity of a first level via the light emission element when the electronic device is operated in a proximity mode; and
emitting light having an intensity of a second level or an intensity of a third level via the light emission element when the electronic device is operated in an iris recognition mode,
wherein the intensity of the third level is greater than the intensity of the second level and the intensity of the first level, and
wherein the intensity of the second level is greater than the intensity of the first level.

13. The method of claim 12, wherein receiving the light comprises:
receiving, via the first light reception element, light which is emitted from the light emission element having the intensity of the second level, and is reflected from the object when the electronic device is operated in the iris recognition mode;
detecting a distance to the object based on the intensity of the light which is reflected from the object;
determining whether to perform iris recognition based on the distance to the object; and
emitting the light having the intensity of the third level via the light emission element upon determination that the iris recognition is performed.

14. The method of claim 13, further comprising:
emitting the light having the intensity of the third level via the light emission element during a first section of an iris recognition period upon determination that the iris recognition is performed;
obtaining iris information based on light emitted from the light emission element and reflected from the object, which is received via the second light reception element; and
performing an authentication procedure based on the iris information.

15. The method of claim 14, further comprising:
determining whether a second section of the iris recognition period arrives if authentication based on the iris information fails;
emitting the light having the intensity of the second level via the light emission element if the second section of the iris recognition period arrives;
receiving light which is emitted from the light emission element and is reflected from the object via the first light reception element; and
detecting a distance to the object based on an intensity of the light reflected from the object; and
determining whether to perform iris recognition based on the distance to the object.

16. The method of claim 13, wherein detecting the distance to the object comprises:
detecting an intensity of light reflected from the object based on an amount of light received via the first light reception element during a light emission section of the light emission element and an amount of light received via the first light reception element during a non-light emission section of the light emission element; and
detecting the distance to the object based on the intensity of the light which is emitted from the light emission element and is reflected from the object.

17. The method of claim 13, wherein determining whether to perform the iris recognition comprises determining whether to perform the iris recognition based on the distance to the object and a pre-defined safety distance.

18. The method of claim 12, wherein the intensity of the third level is set based on at least one of: the distance to the object and a light emission time of the light emission element.

19. The method of claim 11, wherein receiving the light comprises, receiving light reflected from the object via the first light reception element, when the electronic device is operated in a proximity mode and
wherein receiving the light further comprises determining proximity of the object based on the intensity of the light received via the first light reception element.

20. A portable electronic device comprising:
a housing comprising a first surface, a second surface facing a direction opposite the first surface, and a side surface surrounding a space between the first surface and the second surface;
a display exposed via a first region of the first surface;
a speaker exposed via a second region of the first surface and disposed adjacent to a first border of the display;
a light emission element comprising light emitting circuitry exposed via the second region of the first surface and disposed adjacent to the first border of the display;
a first light reception element comprising light receiving circuitry exposed via the second region of the first surface, disposed adjacent to the first border of the display, and having a first resolution;
a second light reception element comprising light receiving circuitry exposed via the second region of the first surface, disposed adjacent to the first border of the display, and having a second resolution higher than the first resolution, the second light reception element being disposed farther away from the light emission element than the first light reception element;
a processor connected to the display, the speaker, the light emission element, the first light reception element, and the second light reception element; and
a memory connected with the processor,
wherein, the memory stores instructions that, when executed by the processor, cause the processor to:
control the light emission element to generate light having a first intensity level during a first time period;
detect at least a part of reflected light of the light of the first intensity level using the first light reception element;
control the light emission element to generate light having a second intensity level which is higher than the first level during a second time period immediately after the first time period;
detect at least a part of reflected light of the light of the second intensity level using the second light reception element;
perform biometric recognition using the detected at least part of the reflected light of the light having the second intensity level; and
perform authentication based on a result of performing the biometric recognition.
